(19) United States
(12) Patent Application Publication
(10) Pub. No.: US 2016/0246155 A1
(43) Pub. Date: Aug. 25, 2016

(54) TIR-MODULATED WIDE VIEWING ANGLE DISPLAY

(71) Applicant: CLEARink Displays, Inc., Santa Clara, CA (US)

(72) Inventors: Andrew LOXLEY, Philadelphia, PA (US); Anthony E. PULLEN, Tucson, AZ (US); Boon Chong NG, Vancouver (CA); Bram M. SADLIK, Vancouver (CA); Rob HANNEBAUER, Vancouver (CA); Alex HENZEN, Bladel (NL)

(21) Appl. No.: 15/143,708

(22) Filed: May 2, 2016

Related U.S. Application Data
(63) Continuation-in-part of application No. 14/903,547, filed on Feb. 5, 2016.

(51) Int. Cl. G02F 1/167; G09G 3/34

(52) U.S. Cl. CPC G02F 1/167; G09G 3/344; G09G 2320/068; G09G 2320/02; G02F 2001/1678

(57) ABSTRACT

Improvements and modifications are provided in the type of frustrated total internal reflection (TIR) systems described in U.S. Pat. Nos. 6,885,496; 6,891,658; 7,286,280; 7,760,417 and 8,040,591. The improvements and modifications include various methods to improve display operation of hemispherical beaded front plane TIR systems such as (a) inhibit or prevent the undesired non-uniform distribution and lateral migration of charged, electrophoretically mobile, TIR frustrating particles by encapsulating or tethering the particles to the beaded front plane surface; (b) inhibit or prevent the settling of the TIR frustrating particles such as modifying the viscosity of the low refractive index medium; and (c) inhibit or prevent the non-uniformity of the applied electric field during display operation such as using a conforming rear electrode.

This application is a Continuation-In-Part (OP) of application Ser. No. 14/903,547 (filed Jan. 8, 2016) which was a National Stage application of PCT Application Serial No. PCT/US2013/049606 (filed Jul. 8, 2013). The specification of each of the foregoing applications is incorporated herein in its entirety.

### TECHNICAL FIELD

This disclosure pertains to frustration of TIR in high brightness, wide viewing angle displays of the type described in U.S. Pat. Nos. 6,885,496; 6,891,658; 7,286,280; 7,760,417 and 8,040,591; all of which are incorporated herein by reference.

### BACKGROUND

FIG. 1A depicts a portion of a prior art reflective (i.e. front-lit) frustrated total internal reflection (TIR) modulated display 10 of the type described in U.S. Pat. Nos. 6,885,496; 6,891,658; 7,286,280; 7,760,417 and 8,040,591. These patents describe an entirely new design of the outward sheet that was previously described in U.S. Pat. Nos. 5,959,777; 5,999,307; 6,064,784; 6,215,920; 6,304,365; 6,384,979; 6,437,921; 6,452,734 and 6,574,025 which comprised of, for example, various spatially uniform prism structures, dielectric light fibers, parallel, and perpendicular and interleaved structures. As a result of the new closely packed, high refractive index, spherical or hemispherical beaded, outward sheet design first described in patents ‘496’ and ‘658’, the practical angular viewing range of frustrated TIR or other reflective display methods was increased. The new design offers semi retro-reflective gain, whereby light rays which are incident on the hemispherical beaded surface are reflected back (but not exactly retro-reflected) toward the light source; which means that the reflection is enhanced when the light source is overhead and slightly behind the viewer, and that the reflected light has a diffuse characteristic giving it a white appearance, which is desirable in reflective display applications.

Display 10 includes a transparent outward sheet 12 formed by partially embedding a large plurality of high refractive index (e.g. η₁>˜1.90) transparent spherical or approximately spherical beads (it is noted that said spherical or approximately spherical beads may also be referred to herein as “hemispherical beads” or “hemi-beads” or “beads”) 14 in the inward surface of a high refractive index (e.g. η₂≈η₁) polymeric material 16 having a flat outward viewing surface 17 which viewer V observes through an angular range of viewing directions Y. The “inward” and “outward” directions are indicated by double-headed arrow Z. Beads 14 are packed closely together to form an inwardly projecting monolayer 18 having a thickness approximately equal to the diameter of one of beads 14. Ideally, each one of beads 14 touches all of the beads immediately adjacent to that one bead. Minimal interstitial gaps (ideally, no gaps) remain between adjacent beads.

An electro-active TIR-frustrating medium 20 is maintained adjacent the portions of beads 14 which protrude inwardly from material 16 by containment of medium 20 within a reservoir 22 defined by lower sheet 24. An inert, low refractive index (i.e. less than about 1.35), low viscosity, electrically insulating liquid such as Fluorinert™ perfluorinated hydrocarbon liquid (η₃˜1.27) available from 3M, St. Paul, Minn. is a suitable fluid for the medium 20. Other liquids such as Novec™ also available from 3M can also be used as the fluid for medium 20. A bead:liquid TIR interface is thus formed. Medium 20 contains a finely dispersed suspension of light scattering and/or absorptive particles 26 such as pigments, dyes, dyed or otherwise scattering/absorptive silica or latex particles, etc. Sheet 24's optical characteristics are relatively unimportant: sheet 24 need only form a reservoir for containment of electro-active TIR-frustrating medium 20 and particles 26, and serve as a support for backplane electrode 48.

As is well known, the TIR interface between two media having different refractive indices is characterized by a critical angle θ_{c}. Light rays incident upon the interface at angles less than θ_{c}, are transmitted through the interface. Light rays incident upon the interface at angles greater than θ_{c} undergo TIR at the interface. A small critical angle is preferred at the TIR interface since this affords a large range of angles over which TIR may occur.

In the absence of TIR-frustrating activity, as is illustrated to the right of dashed line 28 in FIG. 1A, a substantial fraction of the light rays passing through sheet 12 and beads 14 undergoes TIR at the inward side of beads 14. For example, incident light rays 30, 32 are refracted through material 16 and beads 14. The rays undergo TIR two or more times at the bead:liquid TIR interface, as indicated at points 34, 36 in the case of ray 30; and indicated at points 38, 40 in the case of ray 32. The totally internally reflected rays are then refracted back through beads 14 and material 16 and emerge as rays 42, 44 respectively, achieving a “white” appearance in each reflection region or pixel.

A voltage can be applied across medium 20 via electrodes 46, 48 (shown as dashed lines) which can for example be applied by vapour-deposition to the inwardly protruding surface portion of beads 14 and to the outward surface of sheet 24. Electrode 46 is transparent and substantially thin to minimize its interference with light rays at the bead:liquid TIR interface. Backplane electrode 48 need not be transparent. If TIR-frustrating medium 20 is activated by actuating voltage source 50 to apply a voltage between electrodes 46, 48 as illustrated to the left of dashed line 28, suspended particles 26 are electrophoretically moved into the region where the evanescent wave is relatively intense (i.e. within 0.25 micron of the inward surfaces of inwardly protruding beads 14, or closer). When electrophoretically moved as aforesaid, particles 26 scatter or absorb light, thus frustrating or modulating TIR by modifying the imaginary and possibly the real component of the effective refractive index at the bead:liquid TIR interface. This is illustrated by light rays 52, 54 which are scattered and/or absorbed as they strike particles 26 inside the thin (˜0.5 μm) evanescent wave region at the bead:liquid TIR interface, as indicated at 56, 58 respectively, thus achieving a “dark” appearance in each TIR-frustrated non-reflective absorption region or pixel. Particles 26 need only be moved outside the thin evanescent wave region, by suitably actuating voltage source 50, in order to restore the TIR capability of the bead:liquid TIR interface and convert each “dark” non-reflective absorption region or pixel to a “white” reflection region or pixel.

As described above, the net optical characteristics of outward sheet 12 can be controlled by controlling the voltage applied across medium 20 via electrodes 46, 48. The electrodes can be segmented to electrophoretically control the particles suspended in the TIR frustrating, low refractive index medium 20 across separate regions or pixels of sheet 12, thus forming an image.

FIG. 2 depicts, in enlarged cross-section, an inward hemispherical or hemi-bead portion 60 of one of spherical beads 14. Hemi-bead 60 has a normalized radius r=1 and a refractive index η₁. A light ray 62 perpendicularly incident (through material 16) on hemi-bead 60 at a radial distance a from hemi-bead 60's centre C encounters the inward surface of hemi-bead 60 at an angle θ₁ relative to radial axis 66. For purposes of this theoretically ideal discussion, it is assumed that material 16 has the same refractive index as hemi-bead 60 (i.e. η₁=η₂), so ray 62 passes from material 16 into hemi-bead 60 without refraction. Ray 62 is refracted at the inward surface of hemi-bead 60 and passes into TIR-frustrating medium 20 as ray 64 at an angle θ₂ relative to radial axis 66.

Now consider incident light ray 68 which is perpendicularly incident (through material 16) on hemi-bead 60 at a distance

$${a}_{c} = \frac{{η}_{3}}{{η}_{1}}$$

from hemi-bead 60's centre C. Ray 68 encounters the inward surface of hemi-bead 60 at the critical angle θ_{c} (relative to radial axis 70), the minimum required angle for TIR to occur. Ray 68 is accordingly totally internally reflected, as ray 72, which again encounters the inward surface of hemi-bead 60 at the critical angle θ_{c}. Ray 72 is accordingly totally internally reflected, as ray 74, which also encounters the inward surface of hemi-bead 60 at the critical angle θ_{c}. Ray 74 is accordingly totally internally reflected, as ray 76, which passes perpendicularly through hemi-bead 60 into the embedded portion of bead 14 and into material 16. Ray 68 is thus reflected back as ray 76 in a direction approximately opposite that of incident ray 68.

All light rays which are incident on hemi-bead 60 at distances a≧a_{c} from hemi-bead 60's centre C are reflected back (but not exactly retro-reflected) toward the light source; which means that the reflection is enhanced when the light source is overhead and slightly behind the viewer, and that the reflected light has a diffuse characteristic giving it a white appearance, which is desirable in reflective display applications. FIGS. 3A, 3B and 3C depict three of hemi-bead 60's reflection modes. These and other modes coexist, but it is useful to discuss each mode separately.

In FIG. 3A, light rays incident within a range of distances a_{c}<a≦a₁ undergo TIR twice (the 2-TIR mode) and the reflected rays diverge within a comparatively wide arc φ₁ centered on a direction opposite to the direction of the incident light rays. In FIG. 3B, light rays incident within a range of distances a₁<a≦a₂ undergo TIR three times (the 3-TIR mode) and the reflected rays diverge within a narrower arc φ₂<φ₄ which is again centered on a direction opposite to the direction of the incident light rays. In FIG. 3C, light rays incident within a range of distances a₂<a≦a₃ undergo TIR four times (the 4-TIR mode) and the reflected rays diverge within a still narrower arc φ₃<φ₂ also centered on a direction opposite to the direction of the incident light rays. Hemi-bead 60 thus has a “semi-retro-reflective,” partially diffuse reflection characteristic, causing display 10 to have a diffuse appearance akin to that of paper.

Display 10 has relatively high apparent brightness, comparable to that of paper, when the dominant source of illumination is behind the viewer, within a small angular range. This is illustrated in FIG. 1B which depicts the wide angular range α over which viewer V is able to view display 10, and the angle β which is the angular deviation of illumination source S relative to the location of viewer V. Display's 10's high apparent brightness is maintained as long as β is not too large. At normal incidence, the reflectance R of hemi-bead 60 (i.e. the fraction of light rays incident on hemi-bead 60 that reflect by TIR) is given by equation (1):

$$R = 1 - {( \frac{{η}_{3}}{{η}_{1}} )}^{2} \qquad ( 1 )$$

where η₁ is the refractive index of hemi-bead 60 and η₃ is the refractive index of the medium adjacent the surface of hemi-bead 60 at which TIR occurs. Thus, if hemi-bead 60 is formed of a lower refractive index material such as polycarbonate (η₁˜1.59) and if the adjacent medium is Fluorinert (η₃˜1.27), a reflectance R of about 36% is attained, whereas if hemi-bead 60 is formed of a high refractive index nano-composite material (η₁˜1.92) a reflectance R of about 56% is attained. When illumination source S (FIG. 1B) is positioned behind viewer V's head, the apparent brightness of display 10 is further enhanced by the aforementioned semi-retro-reflective characteristic.

As shown in FIGS. 4A-4G, hemi-bead 60's reflectance is maintained over a broad range of incidence angles, thus enhancing display 10's wide angular viewing characteristic and its apparent brightness. For example, FIG. 4A shows hemi-bead 60 as seen from perpendicular incidence—that is, from an incidence angle offset 0° from the perpendicular. In this case, the portion 80 of hemi-bead 60 for which a≧a_{c} appears as an annulus. The annulus is depicted as white, corresponding to the fact that this is the region of hemi-bead 60 which reflects incident light rays by TIR, as aforesaid. The annulus surrounds a circular region 82 which is depicted as dark, corresponding to the fact that this is the non-reflective region of hemi-bead 60 within which incident rays are absorbed and do not undergo TIR. FIGS. 4B-4G show hemi-bead 60 as seen from incident angles which are respectively offset 15°, 30°, 45°, 60°, 75°. and 90° from the perpendicular. Comparison of FIGS. 4B-4G with FIG. 4A reveals that the observed area of reflective portion 80 of hemi-bead 60 for which a≧a_{c} decreases only gradually as the incidence angle increases. Even at near glancing incidence angles (e.g. FIG. 4F) an observer will still see a substantial part of reflective portion 80, thus giving display 10 a wide angular viewing range over which high apparent brightness is maintained.

Display 10 can exhibit undesirable clustering of particles 26 over time. More particularly, particles 26 tend to form loose agglomerates within the TIR-frustrating medium 20, with the surrounding regions of TIR-frustrating medium 20 containing relatively few suspended particles 26. Such clustering of absorptive particles 26 can cause long-term deterioration of display 10's image quality and overall performance. This invention relates to improvements and modifications of display 10 design such as:
a) Non-uniform distribution of the TIR frustrating, electrophoretically mobile particles on the surfaces of the hemispherical beads in the dark state of the system;
b) Settling and clustering of the TIR-frustrating particles;
c) Non-uniformity of the electric field between the electrodes; and

This invention also provides a modified system whereas the dark state depends on the light scattering or absorptive properties of the TIR-frustrating particles within the suspending fluid and not on frustration of TIR.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1A is a greatly enlarged, not to scale, fragmented cross-sectional side elevation view, of a portion of a TIR frustrated or modulated prior art reflective image display.

FIG. 1B schematically illustrates the wide angle viewing range α of the FIG. 1A display, and the angular range β of the illumination source.

FIG. 2 is a greatly enlarged, cross-sectional side elevation view of a hemispherical (“hemi-bead”) portion of one of the spherical beads of the FIG. 1A apparatus.

FIGS. 3A, 3B and 3C depict semi-retro-reflection of light rays perpendicularly incident on the FIG. 2 hemi-bead at increasing off-axis distances at which the incident rays undergo TIR two, three and four times respectively.

FIGS. 4A, 4B, 4C, 4D, 4E, 4F and 4G depict the FIG. 2 hemi-bead, as seen from viewing angles which are offset 0°, 15°, 30°, 45°, 60°, 75° and 90° respectively from the perpendicular.

FIG. 5 is a top plan (i.e. as seen from a viewing angle offset 0° from the perpendicular) cross-sectional view of a portion of the FIG. 1A display, showing the spherical beads arranged in a hexagonal closest packed (HCP) structure.

FIG. 6A schematically illustrates a portion of a TIR-based display comprising two pluralities of particles of the same charge polarity and different mobilities in a first state.

FIG. 6B schematically illustrates a portion of a TIR-based display comprising two pluralities of particles of the same charge polarity and different mobilities in a second state.

FIG. 6C schematically illustrates a portion of a TIR-based display comprising two pluralities of particles of the same charge polarity and different mobilities in a third state.

FIG. 6D schematically illustrates a portion of a TIR-based display comprising two pluralities of particles of the same charge polarity and different mobilities in a fourth state.

FIG. 7 schematically illustrates a portion of a TIR-based display comprising a pixelated color filter layer and two pluralities of particles of the same charge polarity and different mobilities in a first state.

FIG. 8 schematically illustrates a portion of a TIR-based display comprising a pixelated color filter layer and two pluralities of particles of the same charge polarity and different mobilities in a first state.

FIG. 9 schematically illustrates a portion of a TIR-based display comprising three pluralities of particles of the same charge polarity and different mobilities in a first state.

FIG. 10 schematically illustrates a portion of a TIR-based display comprising two pluralities of particles of the same charge polarity and a plurality of particles of an opposite charge polarity in a first state.

FIG. 11 is a greatly enlarged, not to scale, fragmented cross-sectional side elevation view, of a portion of a TIR frustrated or modulated prior art reflective image display with tethered particles in the light (non-frustrated) and dark (frustrated) state.

FIG. 12 is a greatly enlarged, not to scale, fragmented cross-sectional side elevation view, of a portion of a TIR frustrated or modulated prior art reflective image display with the TIR-frustrating, electrophoretically mobile particles confined to a square-like shaped micro-cells. A top view of an array of micro-cells and an enlarged view of a single micro-cell is shown.

FIG. 13 is a greatly enlarged, not to scale, fragmented cross-sectional side elevation view, of a portion of a TIR frustrated or modulated prior art reflective image display containing a plurality of capsules.

FIG. 14 is a greatly enlarged, not to scale, fragmented cross-sectional side elevation view, of a portion of a TIR frustrated or modulated prior art reflective image display containing a plurality of droplets surrounded by a polymer-based continuous phase.

FIG. 15 is a greatly enlarged, not to scale, fragmented cross-sectional side elevation view, of a portion of a TIR frustrated or modulated prior art reflective image display containing a conforming backplane.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The present invention has numerous different aspects. Although these various aspects will for convenience and ease of understanding be described seriatim, it will readily be apparent to those skilled in the technology of electrophoretic displays that several aspects of the present invention may be incorporated into a single device. For example, an encapsulated device could also make use of the viscosity modifier, polymer coated particles and high volume fraction aspects of the invention.

Also, in view of the large number of aspects of the present invention, it is convenient to group the various aspects according to which of the aforementioned problems they are primarily designed to address, as follows:

### Section A: Non-Uniform Distribution of Particles

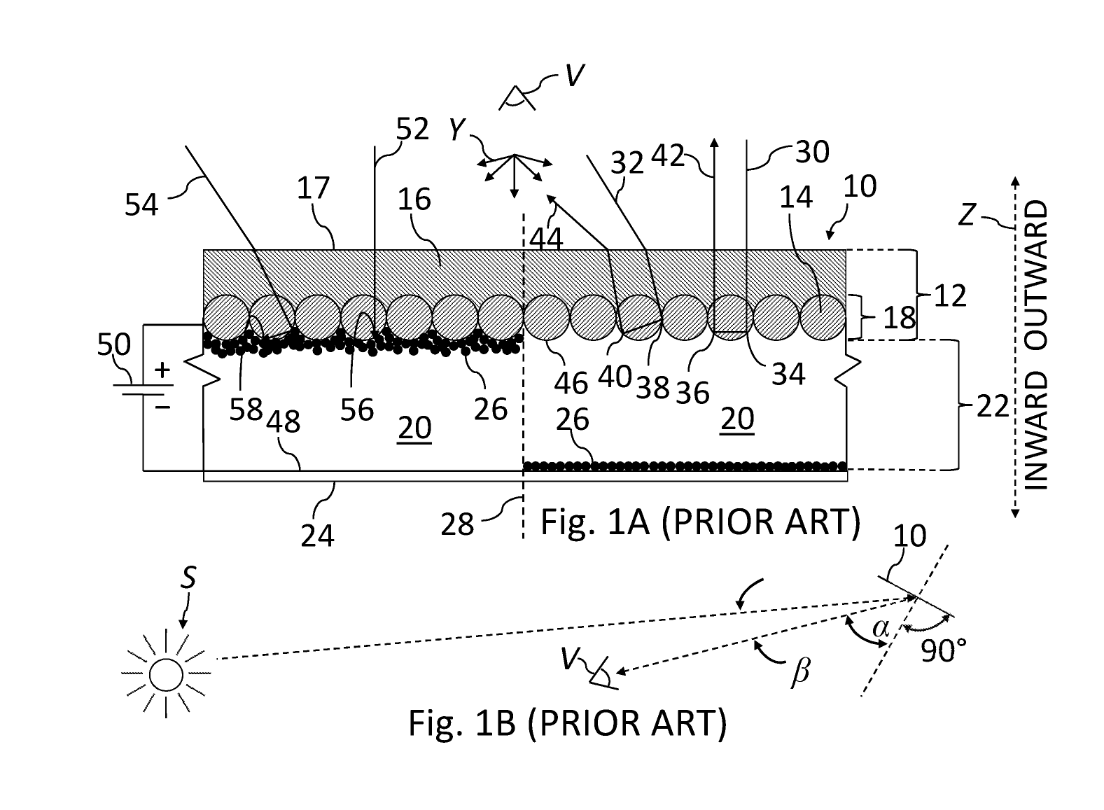

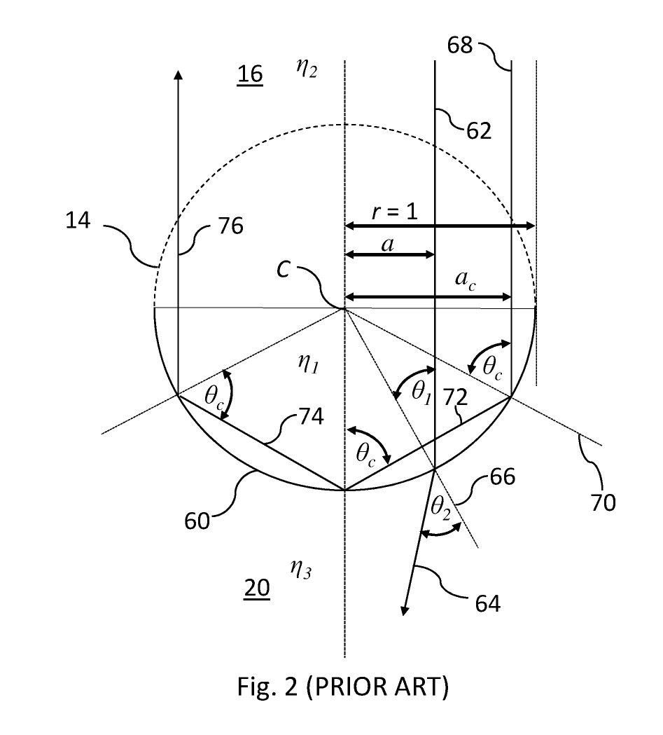

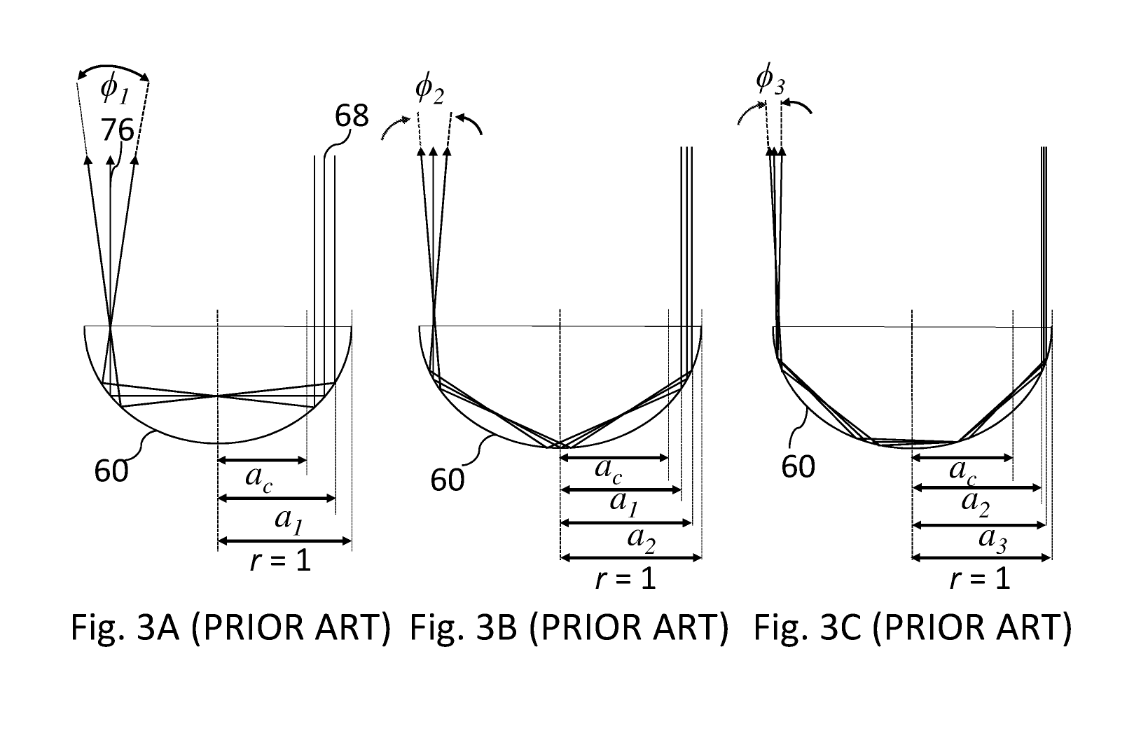

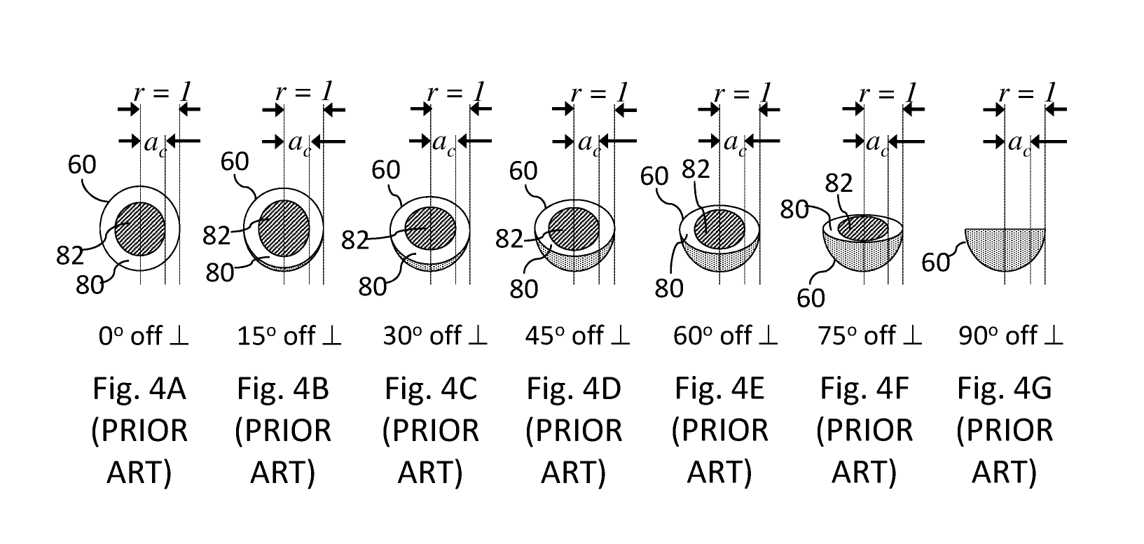

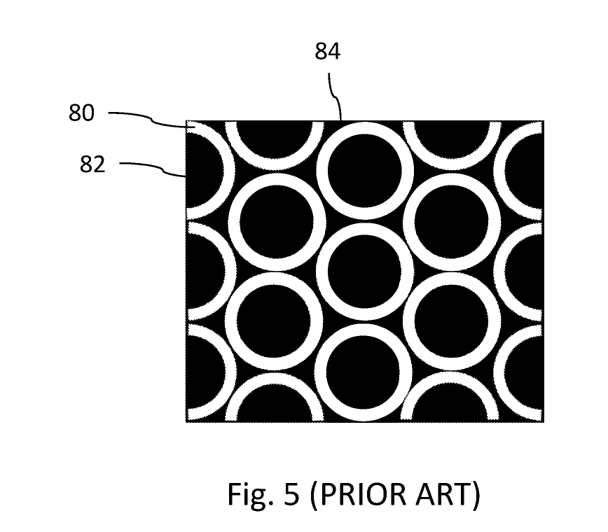

In FIG. 1A, a transparent outward sheet formed by partially embedding a large plurality of high refractive index, transparent spherical or approximately spherical beads in the inward surface of a high refractive index polymeric material having a flat outward viewing surface by which a viewer observes through an angular range of viewing directions. The spherical beads are packed closely together to form an inwardly projecting monolayer having a thickness approximately equal to the diameter of one of beads. Ideally, each one of beads touches all of the beads immediately adjacent to that one bead in a hexagonal closest packed (HCP) arrangement as illustrated in FIG. 5, but can also be arranged in a random-like fashion. Minimal interstitial gaps (ideally, no gaps) remain between adjacent beads. Said arrangement of beads is covered by a transparent conductive layer 46 such as indium tin oxide (ITO—other conductive materials, including conductive polymers may alternatively be used such as Baytron™). The rear electrode also shown in FIG. 1A is provided on a planar surface lying parallel to the outward surface of the reflective sheet. Thus, the distance between the two electrodes varies cyclically, in a wave-like manner, as one traverses the surface of the spherical beads.

As will readily be apparent to those skilled in the technology of image display systems, the cyclic variation in the distance between the channel and rear electrodes causes the electric field between these two electrodes to be non-uniform, and this non-uniform electric field is likely to lead to substantially non-uniform distribution of particles on the walls of the beads in the “dark” state in which TIR is intended to be frustrated. This non-uniform distribution may cause parts of the beaded electrode not to be covered by particles, so that TIR does not occur at these non-covered parts, leading to an undesirably high dark state reflectance. Accordingly, if the particle distribution could be made more uniform, the contrast ratio between the dark and light states of the display could be improved.

It is believed (although the present invention is in no way limited by this belief) that when an electric field is applied across the electrodes to move the light absorbing, TIR-frustrating particles adjacent the beaded electrode, said particles will initially concentrate on the areas of maximum field intensity along the non-uniform surface of the beads, and that thereafter, as the electric field continues to be applied, the particles will tend to spread from these areas of maximum field intensity to areas of lower field intensity. Accordingly, using light absorbing particles with a range of electrophoretic mobilities, in accordance with the variable electrophoretic mobility aspect of the present invention, should improve the uniformity of distribution of the particles in the dark state, since the more mobile particles will already have traveled to the areas of maximum field intensity as the less mobile particles are still reaching the areas of maximum field intensity. The electrophoretic mobilities of the particles may vary from about a two-fold to about a five-fold, or higher range, i.e., at least one of the particles should have an electrophoretic mobility which is at least about twice, and preferably at least about five times, that of another of the particles. Also, with or without using such a range of mobilities, it is important to control the duration of the period during which the electric field is applied to the electrodes (the duration of the “driving pulse”) since too short a pulse will tend to leave the particles concentrated on the areas of maximum field intensity, whereas too long a pulse will allow most particles to move into the “valleys” (the points furthest distant from the rear electrode) between the beads, in either case producing an undesirably non-uniform coverage of the beaded surface. It is also advantageous to use light absorbing particles with high charges since such highly charged particles, when in close proximity to one another on the surface of the beaded electrode, will coulombically repel one another, and will thus tend to more uniformly distribute themselves over the beaded electrode and frustrate TIR.

Particles comprising different mobilities may also be applicable to TIR displays capable of displaying at least three different colors: a white state, color of a first plurality of particles of a first mobility and the color of a second plurality of particles of a second mobility. Intermediate color states may be further possible by mixing the white state and the color of the first or second plurality of light absorbing particles of different mobilities in various ratios.

In one embodiment, the disclosed principles provide a method and apparatus to provide multi-colored frustratable total internal reflection (FTIR)-based displays of various architectures. In an exemplary embodiment, two pluralities of mobile electrophoretic particles of the same charge polarity, different colors and different mobilities may be dispersed in a transparent medium. In another embodiment, three pluralities of mobile electrophoretic particles of the same charge polarity, different colors and different mobilities may be dispersed in a transparent medium. In another embodiment, two pluralities of mobile electrophoretic particles of the same charge polarity, different colors and different mobilities and a third plurality of particles of opposite charge polarity may be dispersed in a transparent medium. The medium may be interposed in the cavity between the first electrode and second electrode. A voltage bias may be applied in the cavity between the first and second electrodes to control the movement of the electrophoretic particles. The FTIR-based display may be capable of displaying at least three different colors depending on the driving scheme employed.

In some embodiments of the disclosure, the FTIR-based displays comprising at least two pluralities of particles may further comprise a directional front light.

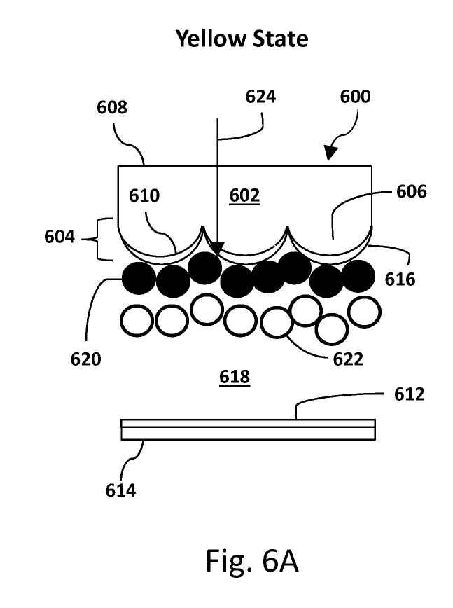

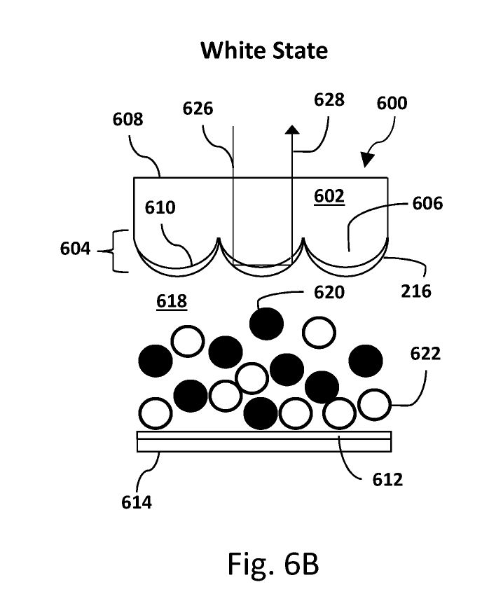

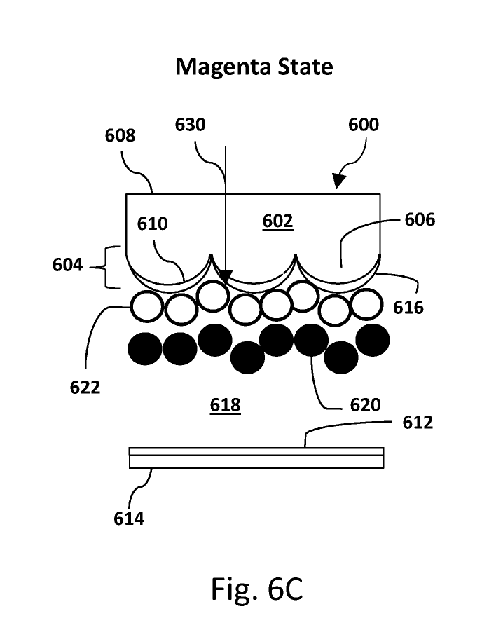

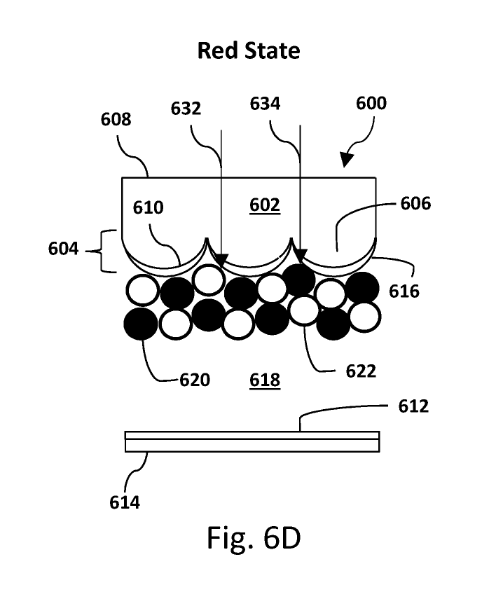

FIG. 6A is a schematic illustration of one embodiment of the disclosure. Specifically, FIG. 6A schematically illustrates a portion of a TIR-based display comprising two pluralities of particles of the same charge polarity and different mobilities in a first state. Display 600 comprises a transparent outer sheet 602 through which a viewer may view the display. Transparent sheet 602 may be a sheet capable of total internal reflection further comprising a plurality 604 of individual convex protrusions 606. The convex protrusions may be in the shape of prisms, hemispheres, beads, hemibeads or hemispherical beads or other shape or a combination thereof. The convex protrusions 606 may be in a close-packed array or a random array or a combination thereof. In some embodiments there may be a gap between at least two of the convex protrusions. In other embodiments there may be no gap. In some embodiments there may be a combination of gaps or the absence of gaps between the convex protrusions. The outer sheet 602 may comprise glass or a polymer, such as polycarbonate or polyethylene terephthalate (PET). Sheet 602 may be a composite of at least one polymer and high refractive index particles. Sheet 602 has an outward surface 608 facing the viewer.

Display 600 may also include a transparent front electrode layer 610 on the inward surface of sheet 602. Layer 610 may comprise indium tin oxide (no) or an electrically conducting polymer such as BAYTRON®. Layer 610 may comprise nanoparticles dispersed in a transparent polymer such as carbon nanotubes or metallic nanowires made from silver or other metals. Front electrode layer 610 may be conformal with the inward surface of the transparent layer 602.

Display 600 may further include a rear electrode layer 612. Rear electrode 612 may comprise of similar material as that of front electrodes 610. It is not necessary that the rear electrode be transparent. Rear electrode 612 may also comprise carbon or conductive metals such as aluminum, copper, silver or gold or other electrically conductive materials or a combination thereof. The rear electrode may comprise at least one of a patterned direct drive array of electrodes, a thin film transistor (TFT) array or a passive matrix array of electrodes. A cavity or reservoir may be formed between the front 610 and rear 612 electrodes. Rear electrode layer 612 may further be supported by rear support sheet 614.

In some embodiments, display 600 may further include at least one optional dielectric layer 616. Dielectric layers provide protective layers for the front or rear electrodes or both the front and rear electrode layers. The dielectric layer may be conformal to the surface where it is placed. The dielectric layers may comprise an inorganic material or an organic material or a combination thereof. In some embodiments the dielectric layers may comprise a polymer such as parylene. In other embodiments the dielectric layers may comprise a halogenated parylene such as parylene C, parylene D, parylene F or parylene AF-4 or a combination thereof. In other embodiments the dielectric layer may be SiO₂ or a combination of SiO₂ with parylene or with a halogenated parylene. In display 600 in FIG. 6A the dielectric layer is illustrated to be on the surface of front electrode layer 610. Though not shown in display 600, a dielectric layer may also be added to the surface of the rear electrode layer 612.

Display 600 may further include a transparent medium 618. In an exemplary embodiment medium 618 is a low refractive index medium (i.e., less than about 1.35). The medium may be air, a clear liquid or any other suitable fluidic medium. The medium may be disposed in the cavity formed by the front electrode 610 and rear electrode 612 layers. In other embodiments, the medium 618 may be colored. The medium may be a hydrocarbon or a fluorinated inert, low refractive index, low viscosity liquid such as a fluorinated hydrocarbon. An inert, low refractive index, low viscosity, electrically insulating liquid such as, Fluorinert™ perfluorinated hydrocarbon liquid (refractive index of ˜1.27) available from 3M, St. Paul, Minn., may be a suitable fluid for the medium.

In an exemplary embodiment, display 600 may further include a voltage source (not shown) to supply substantially uniform voltages to the front and rear electrodes. The voltage source may independently bias each of the electrodes. Alternatively, the voltage source may bias one or both of the electrodes as a function of the bias applied to the other electrode(s). The voltage source may be employed to apply a voltage bias across the cavity formed by the front electrode layer 610 and the rear electrode layer 612. A controller comprising a processor circuitry, a memory circuitry and switching circuitry may be used to drive each of the electrodes. The memory circuitry may store instructions to drive the processor circuitry and the switching circuitry thereby engaging and disengaging electrodes according to predefined criteria.

Display 600 further includes two pluralities of electrophoretically mobile light absorbing particles 620, 622 dispersed in medium 618. The particles may have a positive or negative charge polarity. The particles may comprise an inorganic material such as a metal oxide-based pigment. The particles may comprise a carbon-based material such as carbon black or other carbon-based pigment or dye. The particles may comprise a combination of an inorganic and a carbon based material. In one embodiment, the particles may comprise a metal oxide-based core material with an outer layer or coating of adhered polymer. In another embodiment, the particles may comprise a carbon-based core such as carbon black or graphite with an outer layer or coating of adhered polymer.

In an exemplary embodiment, both of the pluralities of particles may have the same charge polarity, different colors and different mobilities. The mobility of a particle is its ability to move electrophoretically under the influence of an applied voltage bias. Mobility may be described as its rate of movement or the momentum in response to a force such as a bias. There are many factors that may affect the ability of a particle to move under an applied bias. For example, such factors may be the charge density on the particle, the size of the particle, the composition of the particle, the dispersability of the particle in the suspending medium and the density of the particle. Other factors that may affect the particle mobility are temperature and viscosity of the suspending medium. In the embodiment illustrated in display 600, the first plurality of particles 620 has a first color and a first mobility. The second plurality of particles 622 has a second (i.e. different) color and a second mobility. Both pluralities of particles may have the same charge polarity.

The portion of display 600 in FIG. 6A may be operated as follows. In the following description, it is assumed that particles 620 are yellow and particles 622 are magenta for illustrative purposes only. In other embodiments the particles may be any color such as, but not limited to, cyan, magenta, yellow, red, green, blue, black or white. Both particles 620, 622 have the same charge polarity. For illustrative purposes it is also assumed that the particles have a positive charge. The particles may also have a negative charge in other embodiments. For descriptive purposes it is also assumed that yellow particles 620 may be assembled such that they move at a faster rate than the magenta particles 622 through medium 618 under an applied bias.

Applying a negative voltage at the front electrode 610 the positively charged yellow particles 620 may be attracted to and collect near front electrode 610 in the evanescent wave region where TIR may be frustrated. Particles 620 collect first near electrode layer 610 as they move at a higher speed through medium 618. The lower-mobility magenta particles 622 may collect behind particles 620 as they move at a slower speed than particles 620 through medium 618. The desired position of both the yellow and the magenta particles may be maintained by application of one or more appropriate time-varying voltage sequences, or display driving schemes. In one example embodiment, application of a constant negative voltage for a selected period of time may cause the higher-mobility yellow particles 620 to collect near front electrode 610. Under application of a constant negative voltage, lower-mobility magenta particles 622 may also be attracted toward front electrode 610. Because particles 622 may move more slowly than yellow particles 620, magenta particles 622 may be distributed a distance away from yellow particles 620. The applied voltage may then be changed from a constant negative voltage to an alternating polarity. Yellow particles 620 may move back and forth in a region near front electrode 610 and within the evanescent wave region adjacent front electrode 610, whereas magenta particles 622, positioned in a region some distance away from front electrode 610, may move back and forth within a much smaller range than yellow particles 620. When incident light rays enter the display, the yellow particles 620 may absorb the light. This portion of the display appears yellow to the viewer. This is shown by representative light ray 624 entering display 600. Light ray 624 is absorbed by particles 620 creating a yellow state of the display.

It should be noted that the parameters of the driving scheme for the display embodiments described herein may be chosen depending on the mobilities of particles in order to achieve a desired display performance. The parameters of the driving scheme may include the magnitude of the applied voltage bias, length of time of the applied DC or AC bias, frequency of AC switching, etc.

It should also be noted that the electrophoretically mobile particles 620, 622 may be depicted as a monolayer in the schematic illustrations of the display embodiments described herein for ease of illustrative purposes only. Particles 620, 622 may reside at the front or rear electrodes as a monolayer, bilayer or multilayers. This may depend on a variety of factors such as one or more of the concentration of the particles, light absorption properties of the particles, mobility of the particles, the specific application of the display comprising the particles, the desired appearance or optical properties to a viewer, or the composition and morphology of the particles. The pluralities of particles 620 and 622 may also be depicted as having a gap between each of the pluralities of particles. The gap may be large or very small between the pluralities of particles. The gap may be smaller than the width of a particle or larger than the width of a particle.

FIG. 6B schematically illustrates a portion of a TIR-based display comprising two pluralities of particles of the same charge polarity and different mobilities in a second state. Specifically, display 600 in FIG. 6B is the same as shown in FIG. 6A but is in the white or bright state. When a negative bias is applied at the rear electrode layer 612, both of the pluralities of positively charged particles 620, 622 may move out of the evanescent wave region as shown in FIG. 6A and towards the rear electrode layer 612. This creates a white state of the display. This is shown by representative incident light ray 626. As light ray 626 enters the display it may be totally internally reflected back towards the viewer. This is shown by representative reflected light ray 628.

FIG. 6C schematically illustrates a portion of a TIR-based display comprising two pluralities of particles of the same charge polarity and different mobilities in a third state. Specifically, display 600 in FIG. 6C is the same as shown in FIGS. 6A-B but is in a magenta state. In order to achieve a magenta state where the lower mobility magenta particles 622 reside in the evanescent wave region near front electrode 610 and in front of the higher mobility yellow particles, an AC switching (i.e. “dithering”) or other display driving scheme may be used. By applying a bias of alternating polarity, the particles may respond in such a manner as to have a sufficient or uniform layer or concentration of magenta particles 622 in the evanescent region. The yellow particles 620 may reside behind particles 622. The drive scheme may comprise a pulse sequence that is further comprised of one or more factors such as switching rate or frequency, time and amplitude. The components of the drive scheme may be applied in a symmetric or asymmetric fashion. As incident light rays enter the display, they may be absorbed by magenta particles 622 located in the evanescent wave region near front electrode 610. This is illustrated by representative light ray 630 being absorbed by particles 622. This may result in the display exhibiting a magenta color to the viewer. Thus the display 600 in FIG. 6C is in a magenta state.

The electrophoretically mobile particles may be designed and assembled such that they may respond in a predictable manner to various drive schemes. For example, the two pluralities of particles of the same charge polarity may differ in density. Density may be referred to as the measure of mass per unit of volume such as in g/cm³. Particles may differ by their effective densities. Effective densities of particles are calculated by the total density of the core particle and any other layers on the particles. Other layers may include an inorganic shell layer such as SiO₂ or Al₂O₃ or an organic layer such as adsorbed or covalently attached polymer chains.

The two pluralities of particles may differ by their charge densities. Charge density may be referred to as the measure of electric charge per surface area or volume. Particles with higher charge densities may be more responsive to an applied bias.

The two pluralities of particles of different mobilities may also differ by their size, shape, surface morphology or surface area or a combination thereof.

FIG. 6D schematically illustrates a portion of a TIR-based display comprising two pluralities of particles of the same charge polarity and different mobilities in a fourth state. Specifically, display 600 in FIG. 6D is the same as shown in FIGS. 6A-C but is in a red state. A display driving scheme may be applied comprising of one or more components such as bias, switching frequency, time or amplitude in a symmetric or asymmetric fashion until a sufficient mix of yellow and magenta particles may be created to form a red state or other desired color state. As incident light rays enter the display, they may be absorbed by both yellow particles 620 and magenta particles 622. This is illustrated by representative light rays 632 and 634 being absorbed by particles 622 and 620, respectively. This may result in the display exhibiting a red color to the viewer. Thus the display 600 in FIG. 6D is in a red state. Other colors may be created by variable mixing of the yellow 620 and magenta particles 622 by applying various drive schemes.

As described in the preceding paragraphs, the display embodiment illustrated in FIGS. 6A-D is capable of displaying at least three different colors. In other embodiments, other combinations of colored particles may be used to display various colors that may be dependent on the application.

Any of the TIR-based display embodiments comprising two pluralities of particles of the same charge polarity and different mobilities described herein may further include at least one color filter. A color filter layer may be chosen in combination with the color of the two pluralities of particles to create a display capable of displaying colors as required by the application. A color filter layer may be located on the outward surface 608 of front sheet 602 facing the viewer. For example, a display with a cyan color filter may also appear green to a viewer when a first plurality of yellow particles are brought to the front surface in the evanescent wave region to frustrate TIR. This is a first color state. When both particles are moved to the rear electrode and incident light rays are allowed to totally internally reflect, the display may appear cyan in color to the viewer. This is a second color state. If, for example, the second plurality of particles may be magenta in color and move to the inward surface of front sheet 602, the display may appear blue to the viewer. This is a third color state. Intermediate color states may also be created by an appropriate mixture of the two pluralities of particles at the inward surface of front sheet 602. It should be noted that the preceding description of a TIR-based display comprising yellow and magenta colored particles in combination with a cyan color filter is for illustrative purposes only. The pluralities of particles with different mobilities and the color filter layer may be any color as needed for a display application.

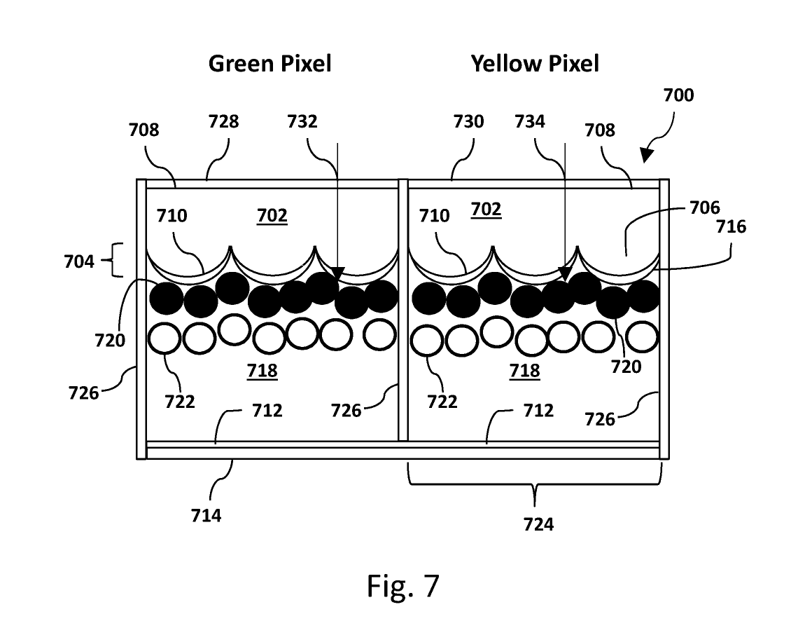

FIG. 7 schematically illustrates a portion of a TIR-based display comprising a pixelated color filter layer and two pluralities of particles of the same charge polarity and different mobilities in a first state. Display 700 in FIG. 7 is similar in construction to display 600. Display 700 includes a transparent front sheet 702 comprising of a plurality 704 of individual convex protrusions 706 on the inward side of sheet 702. Sheet 702 has an outward surface 708 facing the viewer. Display 700 includes a front electrode 710 and rear electrode 712. Rear electrode 712 may be further supported by rear support sheet 714. Display 700 may include at least one optional dielectric layer 716. Disposed within the cavity formed by the front electrode 710 and rear electrode 712 is a transparent medium 718. Dispersed within medium 718 are at least two pluralities of mobile electrophoretic particles 720, 722 of the same charge but different colors and mobilities. Display 700 may further comprise a voltage source (not shown) to supply substantially uniform voltages to the front and rear electrodes.

Unlike in display 600, display 700 may be pixelated and further comprise compartments 724. The compartments may also be referred to as micro-cups, cells, micro-segregated regions or wells. The compartments 724 are divided by sidewalls 726. In some embodiments the sidewalls 726 may completely bridge the rear electrode layer 712 to the front electrode layer 710. In other embodiments the sidewalls may only be on the rear electrode or only on the front electrode layer. In other embodiments the sidewalls may only partially extend from one electrode layer to the opposing electrode layer. The sidewalls may comprise a plastic, metal or glass or a combination thereof.

Display 700 comprises a color filter layer. A color filter layer may be associated with each compartment to form a pixel. In FIG. 7, color filter 728 may be substantially registered with the compartment on the left to form a left pixel. A second color filter 730 of a different color may be substantially registered with the compartment on the right to form a right pixel. In some embodiments the color filter layers may be the same color for each compartment throughout the display. In some embodiments, a color filter may be registered with a compartment while some compartments may not have a color filter within the same display. In some embodiments, a combination of color filters may be used that are of different colors or are clear.

The portion of display 700 in FIG. 7 may be operated as follows. In the following description, it is assumed that the plurality of particles 720 are yellow and plurality of particles 722 are magenta for illustrative purposes only. In other embodiments the particles may be any colors such as, but not limited to, cyan, magenta, yellow, red, green, blue, black, white. Both particles 720, 722 also have the same charge. For descriptive purposes it is also assumed that the particles have a positive charge polarity. The particles may also have a negative charge polarity in other embodiments. For descriptive purposes it is also assumed that yellow particles 720 have a higher mobility than the magenta particles 722 in medium 718 under an applied bias. For descriptive purposes it is also assumed that the color filter layer 728 registered with the left compartment is cyan. It will be assumed that the color filter on the right 730 is transparent and has no color (i.e. clear). Applying an appropriate driving scheme in both compartments the positively charged yellow particles 720 may be attracted to and collect near front electrode 710. The particles may enter the evanescent wave region where TIR is frustrated. Particles 720 may collect first at electrode 710 as they have a higher mobility in medium 718. The lower mobility magenta particles 722 may collect behind particles 720. When incident light rays enter the display in the left compartment and pass through the cyan filter 728 and front sheet 702, the yellow particles 720 may absorb the light. This left compartment portion (i.e. pixel) of the display may appear green to the viewer. This is illustrated by representative light ray 732 entering display 700 and being absorbed by particles 720 creating a green state of the pixel of the display. When incident light rays enter the display in the right compartment and pass through the clear filter 730 and front sheet 702, the yellow particles 720 may absorb the light. This pixel of the display appears yellow to the viewer. This is illustrated by representative light ray 734 entering display 700 and being absorbed by particles 720 creating a yellow state of the pixel of the display.

By applying an appropriate driving scheme, the magenta particles 722 may instead be brought near the inward surface of sheet 702 to frustrate TIR. As a result, the left compartment in FIG. 7 may appear blue to the viewer by combination of a cyan filter and magenta colored particles. The right compartment pixel may appear magenta to the viewer when the particles are brought near the inward surface of sheet 702 with a clear color filter 730. Any combination of colored particles and color filters may be used depending on the desired appearance and application of the TIR-based display.

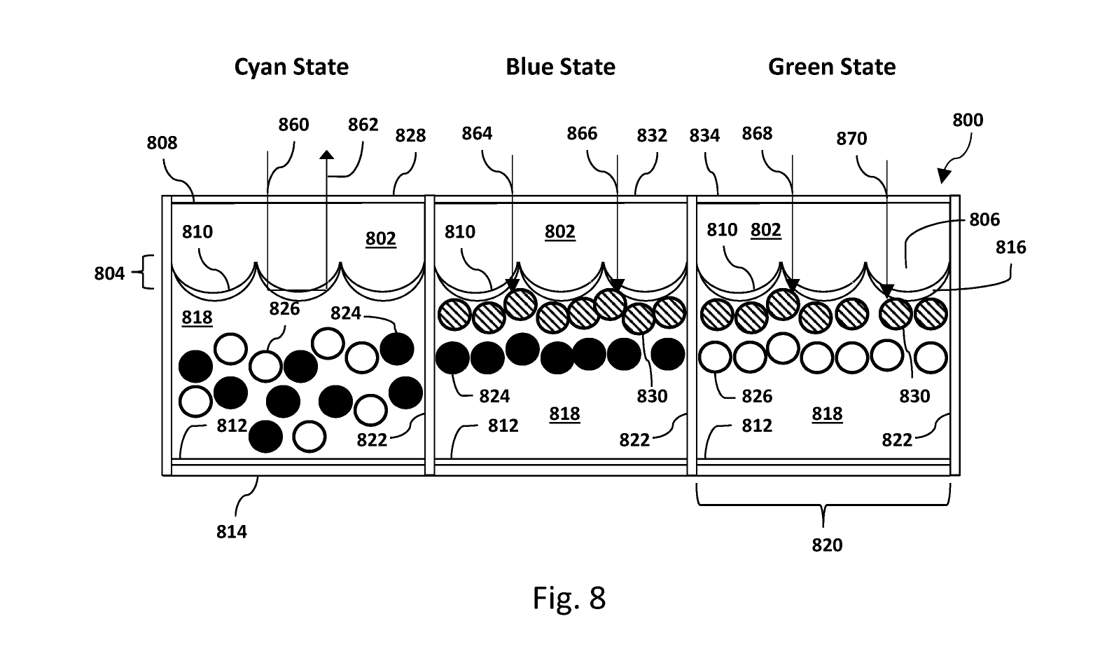

FIG. 8 schematically illustrates a portion of a TIR-based display comprising a pixelated color filter layer and two pluralities of particles of the same charge polarity and different mobilities in a first state. Display 800 in FIG. 8 is similar in construction to pixelated display 700 wherein each pixel comprises a color filter and two pluralities of particles. Display 800 includes a transparent front sheet 802 comprising of a plurality 804 of individual convex protrusions 806 on the inward side of sheet 802. Sheet 802 has an outward surface 808 facing the viewer. Display 800 includes a front electrode 810 and rear electrode 812. Rear electrode 812 may be further supported by a rear support sheet 814. Display 800 may include at least one optional dielectric layer 816. Disposed within the cavity formed by the front electrode 810 and rear electrode 812 is a transparent medium 818. Display 800 is divided into individual compartments 820 by sidewalls similar to display 700. Each compartment 820 may be substantially registered with a color filter to form a pixel. Display 700 comprises two different pixels while display 800 comprises three different pixels. Dispersed within medium 818 within each pixel are at least two pluralities of mobile electrophoretic particles of the same charge but different colors and different electrophoretic mobilities. Display 800 may further comprise a voltage source (not shown) to supply substantially uniform voltage biases to the front 810 and rear 812 electrodes.

In the following description, it is assumed that mobile electrophoretic particles 824 are yellow and particles 826 are magenta and have the same charge polarity in the pixel on the far left in display 800. For illustrative purposes it is also assumed that yellow particles 824 have a higher mobility than the magenta particles 826 in medium 818 under an applied driving scheme. It is also assumed that the color filter layer 828 registered with the far left pixel is cyan. The middle pixel in display 800 comprises cyan mobile electrophoretic particles 830, yellow mobile particles 824 and a magenta color filter 832. It is also assumed that yellow particles 824 have a higher mobility than cyan particles 830 in medium 818 under an appropriate driving scheme. The pixel on the far right comprises cyan mobile electrophoretic particles 830, magenta mobile particles 826 and a yellow color filter 834. It is also assumed that cyan particles 830 have a higher mobility than the magenta particles 826 in medium 818 under an appropriate driving scheme. For illustrative purposes it is also assumed all of the particles in all three pixels have a positive charge polarity and may be of any color. The particles may also have a negative charge polarity in other embodiments. In other embodiments the color filters may be of any color.

The portion of display 800 in FIG. 8 may be operated as follows. In the far left pixel a negative bias is applied to the rear electrode 812. Both pluralities of particles may move out of the evanescent wave region. Incident light ray 860 passes through cyan color filter 828 and may be totally internally reflected back towards the viewer as reflected light ray 862. The pixel may appear cyan to the viewer. In the middle pixel, cyan particles 830 may be electrophoretically moved into the evanescent wave region near front electrode 810. Incident light rays 864, 866 pass through the magenta color filter and are absorbed by cyan particles 830. The middle pixel may appear blue to the viewer. In the pixel on the far right in display 800, cyan particles 830 may be electrophoretically moved into the evanescent wave region near front electrode 810. Incident light rays 868, 870 pass through the yellow color filter 834 and may be absorbed by cyan particles 830. The pixel on the far right in display 800 may appear green to the viewer.

The representative example in FIG. 8 may exhibit multiple pixelated colors. The display design embodiment disclosed herein may be capable of displaying a full spectrum of colors depending on the desired combination of different colored pluralities of particles and different colored color filter layers. In another embodiment a fourth pixel may be added with a combination of black particles and a clear or absent color filter layer. This may provide a pixel capable of displaying a white state.

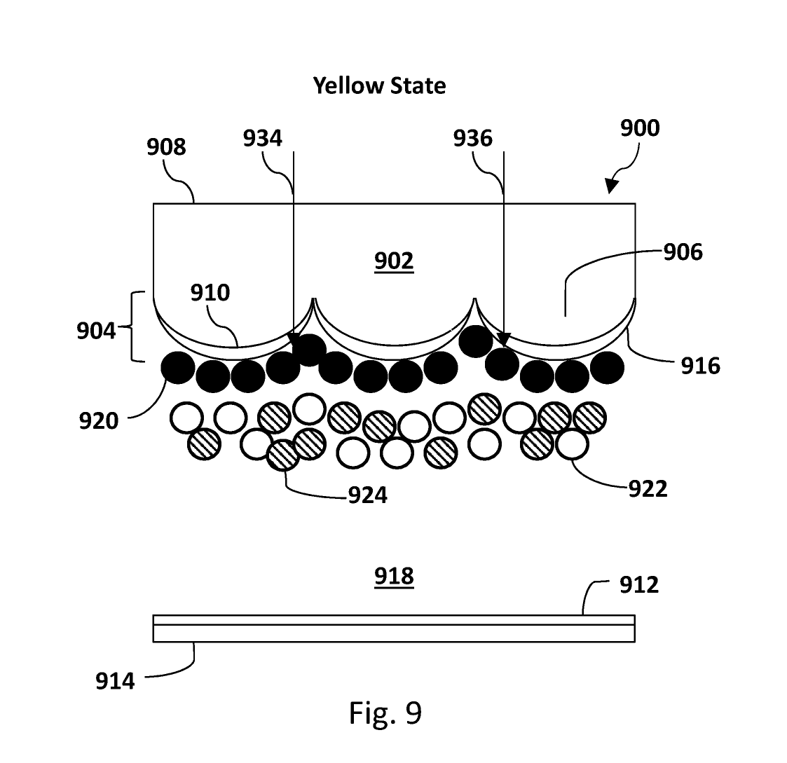

FIG. 9 schematically illustrates a portion of a TIR-based display comprising three pluralities of particles of the same charge polarity and different mobilities in a first state. Display 900 is identical in construction to display 600 except that display 900 comprises three pluralities of particles instead of two. Display 900 may be capable of exhibiting at least eight states of color. Display 900 includes a transparent front sheet 902 comprising of a plurality 904 of individual convex protrusions 906 on the inward side of sheet 902. Sheet 902 has an outward surface 908 facing the viewer. Display 900 includes a front electrode 910 and rear electrode 912. A rear support sheet 914 supports rear electrode 912. Display 900 may include at least one optional dielectric layer 916 that is substantially uniform and conformal. Disposed within the cavity formed by the front electrode 910 and rear electrode 912 is a transparent low refractive index medium 918. Dispersed within low refractive index medium 918 within each pixel are three pluralities of mobile electrophoretic particles 920, 922, 924 of the same charge but different colors and different electrophoretic mobilities. Display 900 may further comprise a voltage source (not shown) to supply substantially uniform voltages to the front and rear electrodes.

The portion of display 900 in FIG. 9 may be operated as follows. In the following description, it is assumed that mobile electrophoretic particles 920 are yellow, particles 922 are magenta and particles 924 are cyan and all have a positive charge polarity. In other embodiments all of the particles may have a negative charge polarity. It will also be assumed in this embodiment for illustrative purposes that under an applied bias particles 920 may electrophoretically have a higher mobility in medium 918, followed by the magenta particles 922 at a lower mobility and followed by the cyan particles 924 at the lowest mobility in the order of: yellow particles 920> magenta particles 922> cyan particles 924. In this representative state, all three pluralities of particles may be attracted to a negative bias at the front electrode 910. Employing a suitable driving scheme comprising one or more of bias, bias magnitude, time and other factors, the highest electrophoretic mobility yellow particles 920 may be moved to the inward surface of sheet 902. The lesser mobility magenta particles 922 and cyan particles 924 may be moved behind particles 920. Incident light rays that enter the display through front sheet 902 may be absorbed by the layer of particles 920. This is represented by light rays 934 and 936. The display in FIG. 9 may appear yellow to the viewer.

By applying an appropriate driving scheme, cyan particles 924 may be moved to the inward surface of sheet 902. The display may appear cyan to the viewer. By applying an appropriate driving scheme the magenta particles 922 may instead be moved to the inward surface of sheet 902. The display may appear magenta to the viewer. Other various color states may also be created by appropriately applying a driving scheme to mix the pluralities of particles at the inward surface of sheet 902.

In other embodiments, display 900 may further include a color filter layer. In other embodiments, display 900 may further comprise individual compartments described previously herein. Each compartment may comprise various combinations of particles of different colors, different mobilities and different charge polarities and may further comprise a color filter layer.

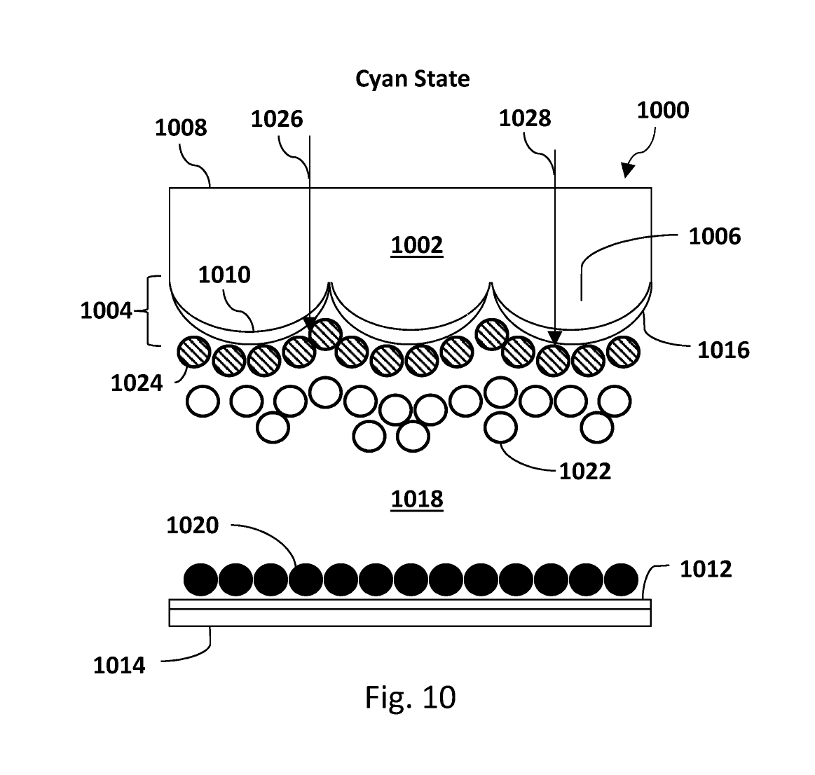

FIG. 10 schematically illustrates a portion of a TIR-based display comprising two pluralities of particles of the same charge polarity and a plurality of particles of an opposite charge polarity in a first state. Display 1000 in FIG. 10 may be identical in construction to display 900 except that display 1000 comprises two pluralities of particles of one charge and different electrophoretic mobilities and a third plurality of particles of an opposite charge polarity. Display 1000 may be capable of exhibiting at least five states of color. Display 1000 includes a transparent front sheet 1002 comprising of a plurality 1004 of individual convex protrusions 1006 on the inward side of sheet 1002. Sheet 1002 has an outward surface 1008 facing the viewer. Display 1000 includes a front electrode 1010 and rear electrode 1012. A rear support sheet 1014 supports rear electrode 1012. Display 1000 may include at least one optional dielectric layer 1016 that is substantially uniform and conformal. Disposed within the cavity formed by the front electrode 1010 and rear electrode 1012 is a transparent medium 1018. Dispersed within low refractive index medium 1018 within each pixel are three pluralities of mobile electrophoretic particles 1020, 1022, 1024. Two of the pluralities of particles have the same charge. The third plurality of particles may have an opposite charge to the two pluralities of particles with the same charge. The three pluralities of particles may all have different colors and different electrophoretic mobilities. In other embodiments some of the particles may have opposite charge polarities but same color or mobilities. Display 1000 may further comprise a voltage source (not shown) to supply substantially uniform voltage biases to the front and rear electrodes.

The portion of display 1000 in FIG. 10 may be operated as follows. In the following description, it is assumed that mobile electrophoretic particles 1020 are yellow, particles 1022 are magenta and particles 1024 are cyan for illustrative purposes only. The yellow particles 1020 have a positively charge polarity and the magenta 1022 and cyan particles 1024 comprise a negative charge polarity. In other embodiments the particles may be of any charge. It will also be assumed in this embodiment that under an appropriate driving scheme, magenta particles 1022 electrophoretically move at a higher mobility in medium 1018 than cyan particles 1024. Applying a negative bias at the rear electrode 1012, the positively charged yellow particles 1020 may be attracted to the rear electrode 1012. The negatively charged cyan particles 1024 and magenta particles 1022 may be attracted to the front electrode 1010 where a positive bias may be applied. Under an appropriate display driving scheme the less electrophoretically mobile cyan particles 1024 may collect at the inward surface of sheet 1002 and enter the evanescent wave region at the front electrode. Employing a suitable driving scheme comprising one or more of bias, bias magnitude, time and other factors, a sufficient layer of cyan particles 1024 may collect at the front electrode layer. Incident light rays, represented by light rays 1026 and 1028, may pass through transparent front sheet 1002 and may be absorbed by the layer of cyan particles 1024. Thus display 1000 shown in FIG. 10 may exhibit a cyan color.

By reversing the applied polarity to the front and rear electrodes, positively charged yellow particles 1020 may be electrophoretically moved to the inward surface of sheet 1002 and the negatively charged particles 1022, 1024 may be moved toward the rear electrode 1012. The display may appear yellow to the viewer.

In other embodiments, display 1000 may further include a color filter layer. In other embodiments, display 1000 may further comprise individual compartments formed by side-walls as described previously herein. Each compartment may comprise various combinations of particles of different colors, different mobilities and different charge polarities and may further comprise a color filter layer.

It should be noted that by employing a suitable waveform or driving scheme comprising of one or more of bias, bias magnitude, time and other factors, multiple intermediate color states may also be exhibited by any of the display embodiments described herein.

It should be noted in the embodiments described herein, a blanking pulse may be employed between desired colored states of the display or to refresh the display. Blanking pulses may be used to place the particles in a similar state before driving them to the next desired state. In some embodiments, a blanking pulse may be used to drive the particles out of the evanescent wave region and towards the rear electrode before the next state. This may make it simpler to drive the particles to the next state instead of when the particles are crowded near the surface of the front electrode.

In other embodiments, any of the reflective image displays comprising two pluralities of particles of the same charge polarity and different mobilities described herein may further include at least one spacer structure. Spacer structures may be used in order to control the gap between the front and rear electrodes. Spacer structures may be used to support the various layers in the displays. The spacer structures may be in the shape of circular or oval beads, blocks, cylinders, columns or other geometrical shapes or combinations thereof. The spacer structures may comprise glass, metal, plastic or other resin.

In other embodiments, any of the reflective image displays comprising two pluralities of particles of the same charge polarity and different mobilities described herein may further include at least one edge seal. An edge seal may be a thermally or photo-chemically cured material. The edge seal may contain an epoxy, silicone or other polymer based material.

In an exemplary embodiment, a directional front light comprising a light guide may be employed with the reflective display embodiments comprising two pluralities of particles of the same charge polarity and different mobilities described herein. The light source may be a light emitting diode (LED), a cathode fluorescent lamp (CCFL) or a surface mount technology (SMT) incandescent lamp.

In some embodiments a light diffusive layer may be used with the display to “soften” the reflected light observed by the viewer. In other embodiments a light diffusive layer may be used in combination with a front light.

In some embodiments, a tangible machine-readable non-transitory storage medium that contains instructions may be used in combination with the reflective displays comprising two pluralities of particles of the same charge polarity and different mobilities described herein. In other embodiments the tangible machine-readable non-transitory storage medium may be further used in combination with one or more processors.

In some embodiments, displays comprising two pluralities of particles of the same charge polarity and different mobilities described herein may further comprise a porous reflective layer. The porous reflective layer may be interposed between the front and rear electrode layers. In other embodiments the rear electrode may be located on the surface of the porous electrode layer.

Another technique to increase the uniformity of particle distribution in the dark and light states and to prevent lateral migration of the particles is to physically tether the particles to the beaded electrode. Image display systems may usefully be modified by tethering light absorbing, TIR-frustrating particles to each other or to a fixed electrode using polymeric chains or similar tethers. The use of such tethers with larger light absorbing particles in TIR-based reflective display systems is practicable because of the very short distance which the particles need to move between the dark and light states. Because frustration of TIR relies upon the particles disrupting the evanescent wave, which penetrates only about 100-250 nm beyond the surface at which the reflection is notionally taking place, particle movement of about 500 nm is sufficient to cause a shift between the light and dark states of the system, and movements of this magnitude are practicable with tethered particles. If tethered particles are used, close attention should be paid to the fluid in which the light absorbing, TIR frustrating particles are suspended in, since solvation of the tether is an important factor in controlling the conformation of the tether and hence the movement of the tethered particle relative to the electrode, and the degree of solvation can be greatly affected by the composition of the suspending fluid.

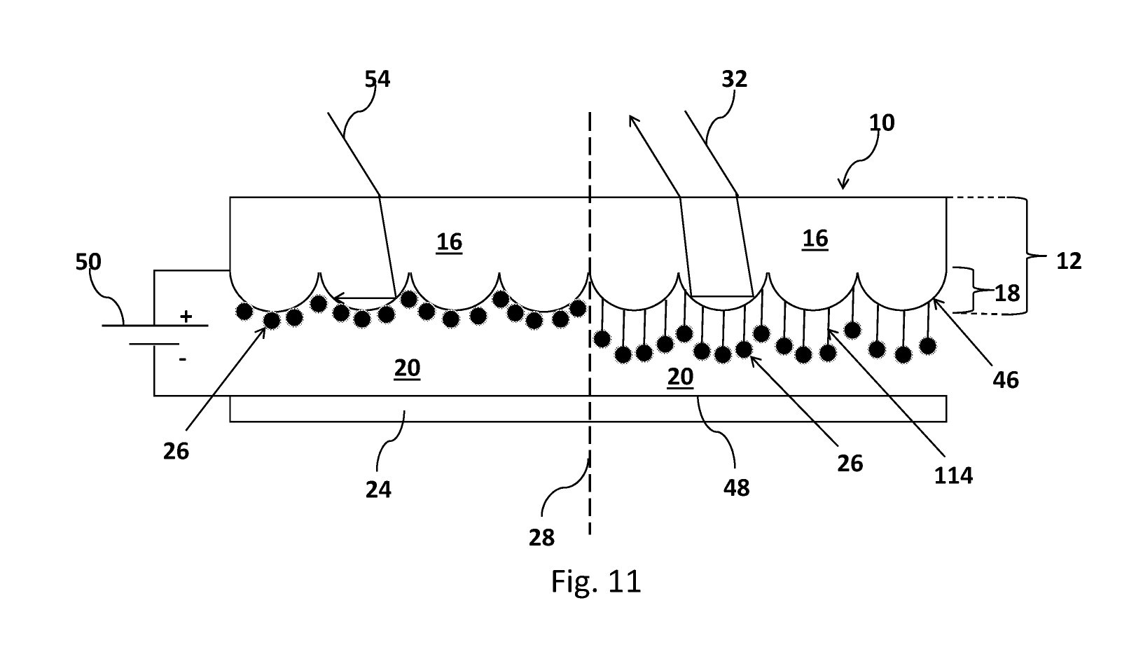

A schematic cross-section through a tethered particles image display device of the present invention is shown in FIG. 11. This device comprises a reflecting sheet (better described as a light transmitting member) 12 having a planar outward surface (the top surface as illustrated in FIG. 11; in actual use, this outward surface typically lies in a vertical plane, so that the plane of FIG. 11 is horizontal) through which an observer views the display. The reflecting sheet 12 has an inward surface having the form of a series of spherical or hemispherical beads 18 (in FIG. 11 the hemispherical bead structure is depicted), which form a wave-like surface structure. Between the electrodes 46 and 48 is disposed a fluidic medium 20 having a refractive index which is sufficiently smaller than the refractive index of the reflecting sheet 12 to permit the TIR's previously mentioned to take place. Suspended within the fluidic medium 20 are a plurality of electrically charged particles 26, each of which is connected to the front electrode 46 by an individual flexible filament or tether 114. The tethers 114 can vary in length, and the number of particles 26 is greatly reduced in FIG. 11 for ease of comprehension; in practice, the number of particles 26 is made somewhat greater than that required to form a continuous layer covering the front electrode 46 in order to ensure that when an electric field is applied to bring the particles 26 adjacent the front electrode 46, substantial complete coverage of the electrode 46 by the particles 26 will be achieved, since even a small area of the electrode 46 not covered by the particles 26 can have a substantial adverse effect on the dark state, and hence the contrast ratio, of the display 10.

FIG. 11 illustrates the light state of the display 10 to the right of the dotted line 28, in which light incident on the outward surface of the reflecting sheet 12 undergoes a double TIR and is returned out through the outward surface in the manner already described. If, however, an electric field of appropriate polarity is applied between the electrodes 46 and 48, the particles 26 will move closely adjacent the front electrode 46 to create a dark state as shown to the left of the dotted line (note that the tethers in the dark state have been removed from FIG. 11 for clarity but are assumed to be present). The particles 26 are chosen to have a refractive index greater than that of the fluid medium 20, such that when the particles lie closely adjacent the front electrode 46, TIR is disrupted, and light incident on the outward surface of the reflecting sheet 12 is no longer returned out through the outward surface, so that the device 10 appears dark.

The limited movement needed to switch between the light and dark states in the beaded outward sheet system also has interesting implications as regards the design of electrophoretically mobile particles to be used in these systems. As a first approximation, the layer of light absorbing, TIR frustrating particles covering the beaded electrode in the dark state of such a system may be modeled as a two-dimensional close-packed array of spheres formed on a flat surface. Such a close-packed array leaves voids immediately adjacent the surface, these voids having a form similar to that of a frustum of a triangular pyramid, with the height of this frustum equal to the radius of the spheres. If this radius is significantly larger than the distance by which the evanescent wave penetrates the flat surface, a proportion of the evanescent wavefront will lie within the voids and hence with not be disrupted by the particles, and the same proportion of the light striking the surface will undergo TIR. (It is of course appreciated that the intensity of the evanescent wave decreases exponentially with distance from the surface so that there is, strictly speaking, no wavefront at a specific distance from the surface. Nevertheless, for present qualitative purposes, it is convenient to consider an evanescent wavefront extending parallel to the beaded wave-like surface at a distance such that the intensity of the wave at the wavefront is some arbitrary fraction, say 1/e, of its intensity at the surface.) Accordingly, the diameter of the particles will affect the proportion of the TIR which is frustrated. In general, it appears that for spherical particles, a diameter of about 200-300 nm (in accordance with one part of the controlled shape particles aspect of the present invention) should be most successful in frustrating TIR.

However, in accordance with another part of the controlled shape particles aspect of the present invention, and from the foregoing discussion, it also appears that spherical or near spherical particles are not the optimum shape for frustrating TIR. Essentially, the ideal situation for disrupting the evanescent wave, and thus frustrating TIR, is to form a continuous layer of material at the evanescent wavefront. While it may be impossible to satisfy this condition in practice, to approach as closely as possible to this condition requires that there be as few gaps as possible in the layer of particles at the relevant distance. To the extent that small particles can assist in filling voids between larger particles, use of a mixture of electrophoretically mobile TIR frustrating particles of differing sizes may be advantageous in leaving as few voids as possible. However, formation of an almost-continuous layer is best achieved by using particles which have substantially greater dimensions in directions parallel to the surface than perpendicular to it. Accordingly, using particles in the form of flat plates or prisms or oblate ellipsoids or spheroids should give better frustration of TIR than using spherical particles. The flat plates or prisms desirably have an aspect ratio (the ratio of average diameter to thickness) of at least about 3:1. Specifically, aluminum flakes having an aspect ratio of about 10:1 and an effective major diameter of about 5-15 μm are available commercially and should be very suitable for use in the beaded outward sheet systems. Similar flakes of other metals may also be employed. Other types of high aspect ratio particles may be employed such as nacreous pigments, pearlescent pigments and other high aspect ratio “effect” pigments.

In beaded outward sheet TIR systems, the structure of the beaded surface, and particularly the optical properties thereof, are of crucial importance in promoting effective frustration of TIR and hence good contrast between the light and dark states of the system. For example, the beaded surface could use a conducting polymer as the electrode in place of indium tin oxide (ITO). Alternatively, in accordance with the low refractive index layer aspect of the present invention, the optical properties of the beaded surface might be modified by using a layer of ITO (or similar conductive material) which is thicker than that required to form a sufficiently conductive electrode, or by coating a low refractive index material, such as magnesium fluoride over the ITO. Note that the use of a low refractive index, or indeed other material over the electrode in this manner may be useful in increasing the range of materials which can be used to form the electrodes. Because of the very low refractive index which is required of the liquid medium with suspended TIR frustrating particles in the beaded TIR systems, a good candidate for the choice of said medium is restricted to highly fluorinated liquids. Certain conductive materials otherwise suitable for use as electrodes in the beaded TIR systems, especially certain conductive polymers, may be adversely affected by long term contact with such highly fluorinated liquids. Covering the electrode with a layer of non-conducting material widens the range of conductive materials which can be used with such liquids. The current required to switch a beaded TIR system is sufficiently low that the presence of a thin layer of a material normally regarded as an insulator over one or both of the electrodes does not have a substantial impact on the operation of the system.

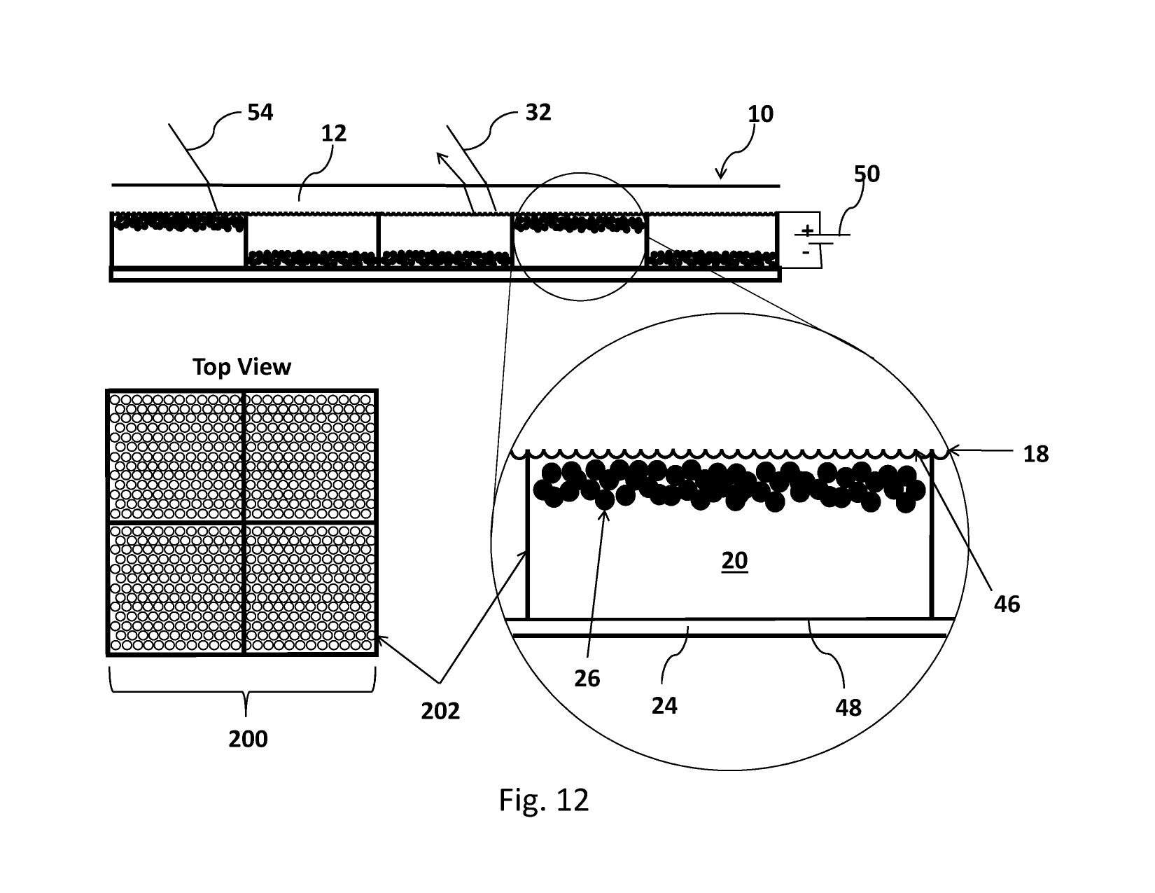

Another technique to increase the uniformity of particle distribution and to prevent lateral migration of particles is to isolate and corral the plurality of particles contained within the liquid medium into individual compartments. The individual compartments are comprised of walls at regular intervals that can be organized in such a way as to form a macroscopic pattern from a plurality of micro-cells (these may also be referred to as “micro-wells”) each of which comprise a low refractive index medium, light absorbing, TIR frustrating particles and any other desired performance enhancing additives. Said macroscopic pattern of micro-cells may comprise a plurality of circle, triangle, square, pentagonal or hexagonal-like walled structures. In one particular embodiment, a schematic cross-section through an image display device of the present invention is shown in FIG. 12, wherein the particles are isolated in a macroscopic array of square-like walled micro-cells. This device designated 10 has a reflecting sheet 12, a support member 24 and electrodes 46 and 48 all of which are identical to the corresponding integers shown in FIG. 1. The light state where the particles are attracted to the rear electrode and away from the beaded front sheet and dark state where the particles are attracted to the beaded front electrode into the evanescent wave region and frustration of TIR of the display are both shown in FIG. 12. A plurality of micro-cells are arrayed in an organized macroscopic arrangement of squares denoted 200 and formed from walls 202. A top view is also shown in FIG. 12 illustrating the side-by-side macroscopic arrangement of micro-cells. The walls of the micro-cells can either be full walls that bridge the rear and front planes and completely encapsulate the liquid medium (as shown in FIG. 12) comprising the light absorbing, TIR frustrating particles or partial walls that do not bridge the rear and front planes completely but enough to slow or prevent migration of particles. The walls may be composed of a polymer material and can be formed into a plurality of wells by numerous techniques such as, but not limited to, molding, pressing, embossing or chemical and physical etching via patterning of a photoresist layer. Other techniques and embodiments for providing an array of micro-cells of the inventions described above will readily be apparent to those skilled in the relevant art.

Another technique to increase the uniformity of particle distribution and to prevent lateral migration of particles is to isolate and corral the plurality of particles contained within the liquid medium by encapsulating the particles 26 and low refractive index medium 20 within a plurality of microcapsules in a beaded outward sheet TIR system 10 described herein. Microcapsules with flexible walls have an advantage when used in a beaded front plane TIR system as opposed to rigid microcapsules. Flexible microcapsules can fill the crevices and voids between the beads on the contoured inward side of the outward sheet electrode surface to resolve optical requirements for TIR displays.

In a beaded outward sheet system using microcapsules, the region lying between the beaded outward sheet electrode and flat rear electrode will be lined with a conforming film of the microcapsule wall material, and obviously the electrophoretically mobile TIR frustrating particles at all times remain separated from the beaded front and planar rear electrodes by the thickness of the microcapsule wall. It is necessary to ensure the particles in contact with the internal surface of the microcapsule wall are sufficiently close to the beaded surface to disrupt the evanescent wave (allowing, of course, for the effect of the refractive index of the microcapsule wall material on the depth of penetration of the evanescent wave) and thus frustrate TIR. There are two approaches to this problem, which may be used separately or in combination. The first approach is to use a microcapsule wall material which has a refractive index which does not differ from the refractive index of the reflective sheet by more than about 0.3, and preferably not more than about 0.2; for example, certain methacrylate polymers have refractive indices within the desired range. In this case, the microcapsule becomes, optically, part of the material forming the beads, and the interface at which TIR occurs is that between the microcapsule wall and the low refractive index medium, and the TIR frustrating particles can thus lie immediately adjacent this interface. The second approach uses a very thin microcapsule wall (less than 200, and preferably less than 100 nm) to ensure that the evanescent wave penetrates into the low refractive index liquid medium. It may also be desirable to increase the viscosity of the medium using a viscosity modifier, and the preferred viscosity modifiers for this purpose are the same as those described below for viscosity modifier devices of the present invention.

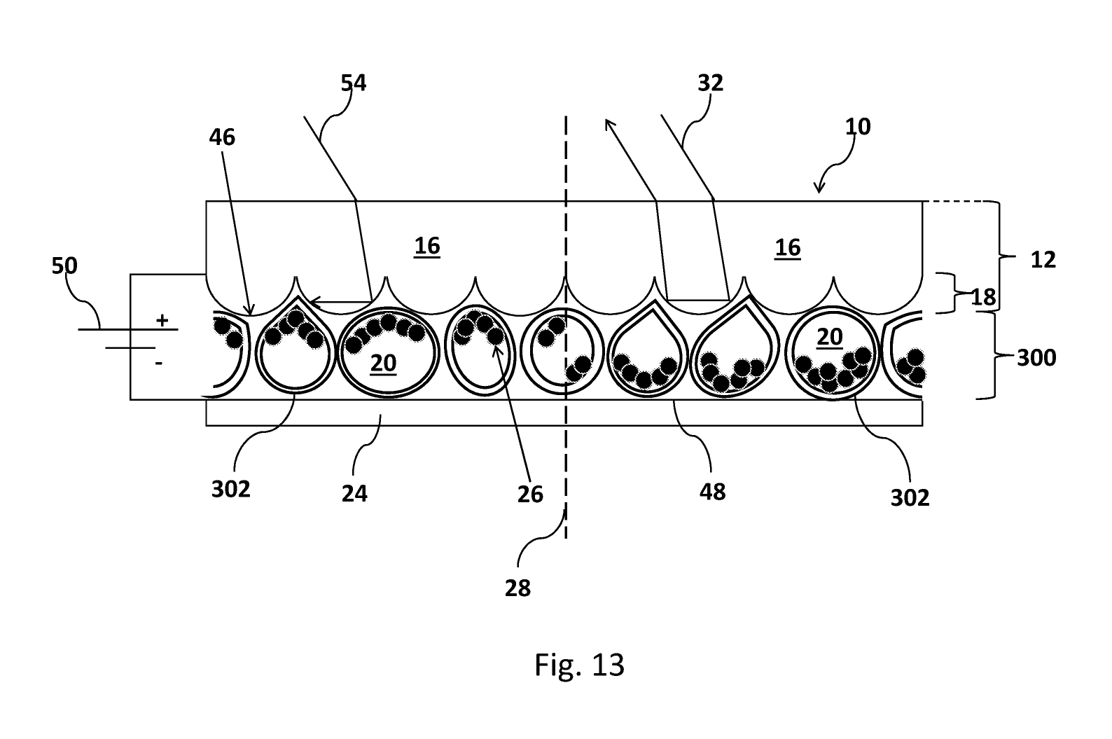

FIG. 13 of the accompanying drawings is a schematic cross-section through an encapsulated device of the present invention. This device designated 10 has a reflecting sheet 12, a support member 24 and electrodes 46 and 48 all of which are identical to the corresponding integers shown in FIG. 1. However, in the device 10 the low refractive index liquid medium 20 and the particles 26 are confined within a plurality of capsules (generally designated 300) each defined by a capsule wall 302. These capsule walls 302 are deformable, so that when the capsules are deposited upon the reflecting sheet 12 and the support 24 thereafter placed on top of the capsules 300 to form the complete device 10. The individual capsule walls 302 deform to substantially fill the space between the sheet 12 and the support 24, assuming the essentially wave-like, beaded surface structure form shown in FIG. 13.

Another approach to increase the uniformity of particle distribution and to prevent lateral migration of particles in beaded outward sheet TIR display systems described herein is to use a polymer-dispersed low refractive index liquid medium which comprises a discontinuous phase containing the liquid medium and light absorbing, electrophoretically-mobile, TIR frustrating particles and a continuous phase essentially free from such particles. The discontinuous phase is comprised of a plurality of droplets, each of which comprise a low refractive index medium and at least one particle disposed within the suspending fluid and capable of moving through the fluid upon application of an electric field, and the continuous phase surrounding and encapsulating the discontinuous phase, the discontinuous phase comprising at least about 40 percent by volume of the liquid medium comprising the electrophoretically mobile particles and any other additives. The continuous phase surrounds and encapsulates the discontinuous phase, thus providing a cohesive medium.

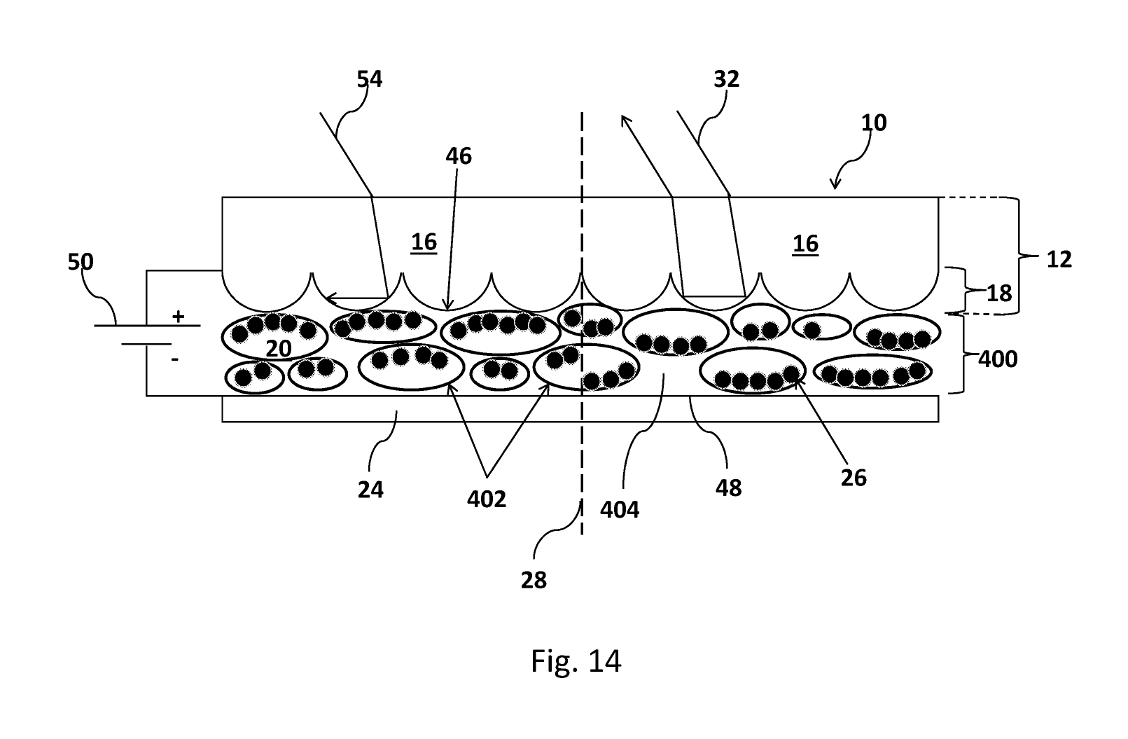

In the present polymer dispersed medium 400 shown in FIG. 14 lying between the beaded front plane 12 with electrode 46 and rear electrode 48, the discontinuous phase (droplets) may comprise from about 40 to about 95 percent by volume of the medium, but preferably comprises about 50 to about 80 percent by volume. The optimum proportion of droplets will of course vary with the specific materials employed, but will typically be in the range of about 60 to about 70 percent by volume. If the proportion of droplets is too high, the polymer dispersed 400 is mechanically weak and easily damaged, and droplets may leak from the medium upon rough handling. On the other hand, it is undesirable to use a proportion of continuous phase substantially larger than that required to provide mechanical strength to the medium. As is well-known to those knowledgeable concerning related electrophoretic displays, such displays normally comprise a thin layer of the electrophoretic medium between two electrodes, so that at any given operating voltage between the electrodes, the field applied to the electrophoretic medium is inversely proportional to its thickness. If excess continuous phase is used in the present medium, the thickness of the medium needed to provide a given amount of droplets will be unnecessarily increased, so that either the applied field will be reduced (and the switching time of the display thereby increased) or the operating voltage must be increased, either of which is undesirable. An unnecessarily excessive amount of continuous phase will also likely increase the distance of a droplet comprising the electrophoretically mobile TIR, frustrating particles and low refractive index medium from the beaded surface which will have a negative effect on the ability to frustrate TIR.

The droplets may comprise a single type of particle disposed in a low refractive index medium, or two or more types of particles, differing in electrophoretic mobility. The electrophoretically mobile, TIR-frustrating particles may comprise, but not limited to, carbon black. The low refractive index medium may comprise, but not limited to, Fluorinert™ FC-770, FC-43, FC-75, Novec™ 649 or 7500. The droplets are about less than 20 μm in thickness, and the medium comprising the discontinuous droplets and continuous film-forming phase may have a thickness of 50 μm to up to about 200 μm.

As already indicated, the medium 400 of the present invention is prepared by dispersing the droplets in a liquid medium containing a film-forming material, and then subjecting the liquid medium to conditions effective to cause the film-forming material to form a film and thus produce the two-phase polymer dispersed medium in which the film-forming material forms the continuous phase and the droplets for the discontinuous phase. The initial dispersion or emulsification of the droplets in the liquid medium may be effected by any of a variety of conventional techniques, for example rapid stirring of a mixture of the liquid medium and the material which will form the droplets, or sonication of such a mixture. Devices suitable for forming the droplets also include, but are not limited to, blade mixers, rotor-stator mixers and colloid mills, devices in which a liquid stream is pumped at high pressures through an orifice or interaction chamber (such as the Microfluidizer sold by Microfluidics), sonicators, Gaulin mills, homogenizers, blenders, etc. The dispersion or emulsification may also be effected by shearing, using a colloid mill or similar apparatus. It should, however, be noted that the presence of the TIR frustrating particles within the droplets tends to make a dispersion or emulsion of such droplets less stable than a similar emulsion or dispersion of the same materials in which the droplets do not contains solid particles, and hence in the present process it is preferred to use a liquid medium which can solidify rapidly.

The continuous phase which is also referred to as the film-forming material will be organic or bioorganic-based. It may be a gelatin, such as lime-processed gelatin, acid-processed pig gelatin or acid-processed ossein gelatin, or a modified gelatin such as acetylated gelatin, phthalated gelatin, oxidized gelatin, etc. Other film formers include water-soluble polymers and co-polymers including, but not limited to, poly(vinyl alcohol), partially hydrolyzed poly(vinyl acetate/vinyl alcohol), hydroxyethyl cellulose, poly(vinylpyrrolidone), and polyacrylamide. Copolymers of these with hydrophobic monomers, such as t-butyl acrylamide, or isopropyl acrylamide can also be used. Polymeric film formers that are also capable of gelation upon application of high or low temperature are particularly useful. Such materials include the various gelatins described above, cellulosic materials, and homopolymers or copolymers containing isopropyl acrylamide. Additional film formers that may be used are polymers soluble in hydrocarbon-based solvents such as, but not limited to, polyacrylates, polymethacrylates, polyamides, epoxys, silicones and polystyrene. The film forming materials mentioned herein may formed and cured using radiation (typically ultra-violet light-curable), cooling, drying, polymerization, cross-linking, sol-gel formation, and pressure-curing. After curing of the organic polymer film-forming material using the methods described, it will comprise of at least about 5 percent to about 15 percent by weight of the film 400 shown in FIG. 14. The thickness of the final film comprising the discontinuous and continuous phases is at least about 10 μm.

FIG. 14 of the accompanying drawings is a schematic cross-section through an encapsulated device of the present invention which further illustrates the invention. This device designated 10 has a reflecting sheet 12, a support member 24 and electrodes 46 and 48 all of which are identical to the corresponding integers shown in FIG. 1. However, in the device 10 the low refractive index medium 20 (The low refractive index medium may comprise, but not limited to, Fluorinert™ FC-770, FC-43, FC-75, Novec™ 649 or 7500) and the TIR frustrating particles 26 are confined within a plurality of discontinuous phase droplets (generally designated 400) surrounded by a continuous phase 404. These droplets 402 are deformable, so that when the medium 400 comprising the discontinuous droplet phase 402 and the surrounding continuous phase 404 are deposited upon the reflecting sheet 12 and the support 24 and then dried the individual droplets 402 deform and flatten as medium 400 contracts between the sheet 12 and the support 24, as shown in FIG. 13. As medium 400 contracts upon drying and or curing the droplets flatten and become closer to the beaded front plant 12, close enough such that when the dark state is created upon application of an electric field the particles in the droplets are attracted to the beaded front electrode surface into the evanescent wave region and frustrates TIR.

### Section B: Settling of Particles

One problem which the beaded outward sheet system described herein 10, shares with many other prior image display systems comprising particles is settling of the TIR frustrating particles under gravity so that after long usage the particles occupy and drift to various locations of the space between the front and rear electrodes leading to an uneven distribution of the particles throughout the low refractive index liquid medium. Note that since, in the beaded outward sheet system, particles are free to move between beads as they are moved from the beaded front electrode to the rear electrode, then in the reverse direction, the systems will suffer from particle settling if the region of the liquid medium 20 between the beaded front plane electrode and flat back electrode 48 lie at an angle to the horizontal, and in most display applications it is impossible to keep the region horizontal when the display is in use.

A technique for dealing with the settling problem is to increase the viscosity of and/or gel the low refractive index fluid medium with the suspended TIR frustrating particles, for example by dissolving a polymer in the liquid medium. Although such an increase in viscosity will decrease the mobility of the particles, and hence the switching time (the time required to switch the display between its dark and light states) will be increased, a modest increase in switching time can be tolerated since the switching times of beaded outward sheet TIR systems can be made very low, because of the very short distances which the particles need to move between the light and dark states. Furthermore, if the viscosity modifier comprises a polymer having an intrinsic viscosity of η in the low refractive index medium and being substantially free from ionic or ionizable groups in the low refractive index medium, the polymer being present in the low refractive index is medium in a concentration of from about 0.5 η⁻¹ to about 2.0 η⁻¹, very substantial increases in the bistability of the device can be produced at the expense of only a modest increase in switching time. Polymers for use as a viscosity modifier may be, but not limited to, non-aromatic, fluorinated and perfluorinated polyolefins and polysiloxanes with number average molecular weights in excess of about 50,000 and more preferably in excess of about 100,000.

A further technique for reducing, or at least deferring, the effects of particle settling is to reduce the difference in density between the TIR frustrating, electrophoretically mobile particles and the low refractive index medium; this approach also widens the range of materials which can be used in such particles. The density of many types of TIR frustrating particles can be reduced by attaching polymer chains. For example, U.S. Pat. No. 6,215,920 recommends using either “dyed or otherwise scattering/absorptive silica particles” or “dyed or otherwise scattering/absorptive latex particles” in TIR systems, because of the low specific gravities of these materials (given as about 1.44 for silica and about 1.5 for latex particles) are tolerable for use with the low specific gravity, low viscosity fluorinated alkane, low refractive index liquid medium with which they are intended to be used. Carbon black may be suitable material for the light absorbing particles but the density of untreated carbon black may be too high to be useful in TIR systems described herein. By attaching polymer chains to the carbon black, its density could be reduced sufficiently to render it useful in such systems. It is recommended that the carbon black particles have from about 1. to about 25 percent by weight of the carbon black of the polymer chemically bonded to, or cross-linked around, the carbon black particles.

Attachment of polymer to the electrophoretically mobile, TIR frustrating particles has uses other than altering the density thereof. For example, such polymer attachment may be useful in increasing or decreasing the effective refractive index of the particles. A high refractive index particle may be useful for increasing optical coupling between the particle and the surface of the beaded front plane electrode, thus promoting efficient frustration of TIR, and for this purpose the polymer coating may contain repeating units derived from arsenic-containing monomers. If a low refractive index particle is desired, the polymer coating may contain repeating units derived from highly fluorinated monomers.

A different approach to the settling problem is to increase the volume fraction of the suspended particles in the low refractive index liquid medium described in U.S. Pat. No. 6,865,011 for TIR display systems comprised of an outward sheet with prism structures. As already noted, to frustrate TIR it is necessary for the particles to be within about 250 nm of the beaded front plane surface. Conversely, a spacing of 500 nm or greater between the beaded surface and the particles will permit full TIR. If the volume fraction of the particles in the low refractive index medium is increased above about 25 percent, and perhaps as high of about 75 percent (depending upon factors such as the size distribution and shape of the particles), the particles will be unable to undergo substantial settling, since they almost “fill” the liquid medium 20, but when an electric field of appropriate polarity to cause a “white” state of the display is applied between the electrodes, a narrow gap, conforming to the shape of the beaded surface, will be cleared of the electrophoretically mobile TIR frustrating particles, thus permitting TIR to occur. A dispersant such as, but not limited to, Krytox™ 157-FSL, Krytox™ 157-FSM or Krytox™ 157-FSH fluorinated oil (respectively having specified molecular weights of approximately 2500, 3500-4000 and 7000-7500, CAS Registry No. 860164-51-4, DuPont Performance Lubricants, Wilmington, Del. 19880-0023) is preferably added to the suspension to facilitate stable suspension of the particles in the low refractive index medium.

### Section C: Non-Uniformity of Electric Field

One problem in beaded outward sheet TIR display systems is the non-uniformity of the electric field between the planar rear electrode and the non-planar, wave-like beaded front plane electrode surface. This problem is best overcome by making the rear electrode substantially conform to that of the beaded electrode so that a gap of substantially constant width (though having a wave-like form as seen in cross-section) remains between the electrodes. The electric field between such electrodes, except in the adjacent peaks, valleys and recesses of the contoured surface, will lie perpendicular to the electrode surfaces.

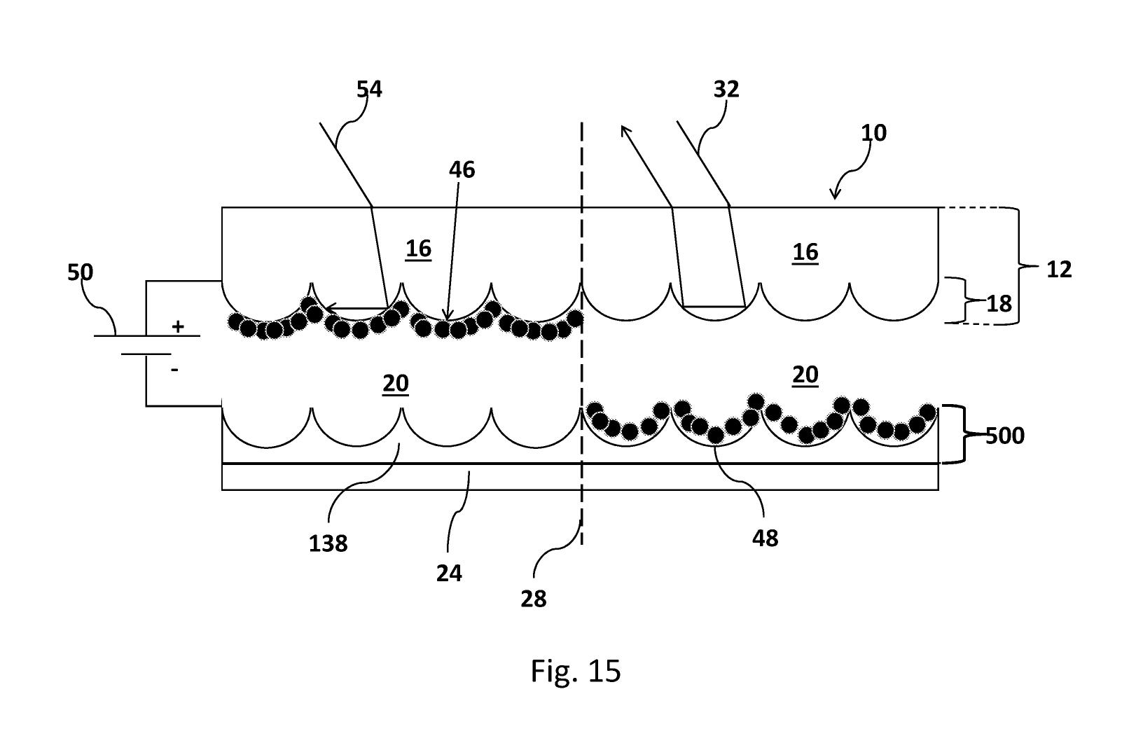

The shaping of the rear electrode can be effected in various ways. The material supporting the back electrode could be a polymer to provide the desired conforming shape of the rear electrode and coated with a conductor in the same way as for the beaded front plane electrode. To provide proper alignment between the two electrodes, it may be desirable to provide projections on one of the electrode-bearing sheets, with corresponding recesses on the other. Alternatively, the rear electrode itself could be shaped to provide the appropriate surface. For example, a layer of metal could be deposited on a substrate and shaped, possibly by electrochemical machining, to provide the necessary conforming surface shape of the rear electrode. A further possibility is shown in FIG. 15 of the accompanying drawings, which illustrates a system comprising a conforming rear support 500 and electrode 48. As shown in FIG. 15, this system (generally designated 10) has a reflecting sheet 12, a space comprising of the electrophoretically mobile, TIR frustrating particles and low refractive index liquid medium, a support member 24 and electrodes 46 and 48 all of which are identical to the corresponding integers shown in FIG. 1. The conforming backplane system 500 of the display system 10 closely conforms to the shape of the beaded front plane 18 so that only a thin layer of liquid medium 20 containing electrophoretically mobile particles 26 is present in the system. The beaded front plane outward sheet structure 12 and the conforming backplane structure 500 may preferably be registered with respect to each other but also may be slightly offset with respect to each other.

Instead of using a shaped backplane to control the movement of the particles in a beaded outward sheet TIR display system described herein, particle movement could be controlled by using a mixture of two immiscible liquids as the electrophoretically controlled medium. If the medium comprises two immiscible liquids, one of which wets the beaded electrode material and the other does not (it being assumed that the rear electrode is formed of a different material which is not wetted by the first liquid) and the proportions of the two liquids are adjusted appropriately, the “wetting” liquid will form a thin layer adjacent and conforming to the beaded electrode. The properties of the particles can be adjusted so that the particles have a lower free energy when dispersed in one of the liquids than in the other. Accordingly, the particles may only move within the layer of the wetting liquid. Alternatively, movement of the particles between the two liquids could be used to provide a threshold for switching of the system, thus opening up the possibility of passive matrix driving of the system.

Finally, a beaded outward sheet TIR display system may be modified by using particles containing multiple absorption or scattering centers. Consider a “raisin bun” particle in which a plurality of small light-scattering and/or light-absorptive centers (formed, for example, from carbon black) are distributed within a light-transmissive matrix. If such particles are present in a beaded outward sheet system adjacent the surface at which TIR would otherwise occur (at the beads), and the refractive index of the matrix is not too dissimilar to that of the material forming the surface, the light reaching the surface will enter the matrix and will be scattered and/or absorbed by the various centers, so that essentially none of the light emerging from the surface re-enters that surface. The optical effect of the particle will thus be identical to frustrated TIR, although achieved by a different mechanism. This type of particle permits a wider choice of materials to be used in beaded TIR systems.

The inventions described in Sections A-C to prevent particle migration and settling and to reduce or eliminate non-uniformity in the electric field in beaded front plane, TIR-frustratable displays may be used in applications such as, but not limited to, electronic book readers, portable computers, tablet computers, cellular telephones, smart cards, signs, watches, shelf label or flash drives. The displays may be powered or charged by one or more of a battery, solar cell, wind, electrical generator, piezoelectrically, electrical outlet, AC power, DC power or other means.

The following examples illustrate further non-exclusive embodiments of the disclosure. Example 1 relates to a Total Internal Reflection (TIR) display, comprising: a transparent TIR sheet, wherein the transparent TIR sheet further comprises a planar surface and a non-planar surface; a transparent front electrode; a rear electrode positioned across the transparent electrode to form a gap therebetween; a first plurality of electrophoretically mobile particles disposed in the gap, the first plurality of particles having a first charge polarity, a first color and a first mobility; and a second plurality of electrophoretically mobile particles disposed in the gap, the second plurality of particles having a second charge polarity, a second color and a second mobility.

Example 2 relates to the display of example 1, wherein the non-planar surface further comprises one or more protrusions extending from away from the planar surface.

Example 3 relates to the display of any preceding example, further comprising a plurality of convex protrusions forming one of a closed-packed array or a random array or a combination of closed-packed array and a random array of convex protrusions.

Example 4 relates to the display of any preceding example, wherein the transparent front electrode is formed over the one or more protrusions extending away from the planar surface.

Example 5 relates to the display of any preceding example, wherein the transparent front electrode is integrated with the transparent TIR sheet.

Example 6 relates to relates to the display of any preceding example, wherein the first charge polarity and the second charge polarity are substantially identical and wherein the first color is different from the second color.

Example 7 relates to the display of any preceding example, wherein the first charge polarity and the second charge polarity are substantially identical and wherein the first mobility is different from the second mobility.

Example 8 relates to the display of any preceding example, wherein the first charge polarity is different from the second charge polarity.

Example 9 relates to the display of any preceding example, further comprising a third plurality of electrophoretically mobile particles having a third charge polarity, a third color and a third mobility.

Example 10 relates to the display of any preceding example, wherein the first charge polarity is substantially similar to the second and the third charge polarities and wherein the first mobility is higher than the second mobility and the second mobility is higher than the third mobility.

Example 11 relates to the display of any preceding example, further comprising a color filter.

Example 12 relates to the a method to provide a Total Internal Reflection (TIR) display, comprising: disposing a first plurality of electrophoretically mobile particles in a gap between a front electrode and a rear electrode of the TIR display, the first plurality of particles having a first charge polarity, a first color and a first mobility; disposition a second plurality of electrophoretically mobile particles in the gap between the front electrode and the rear electrode, the second plurality of particles having a second charge polarity, a second color and a second mobility; and biasing the front electrode relative to the rear electrode to cause a movement of the first and the second plurality of electrophoretically mobile particles from the front electrode to the rear electrode; wherein the movement of the first plurality of electrophoretically mobile particles from the front electrode to the rear electrode is faster relative to the movement of the plurality of second electrophoretically mobile particles from the front electrode to the rear electrode.

Example 13 relates to the method of example 12, wherein the front electrode further comprises one or more protrusions extending towards the gap.

Example 14 relates to the method of any preceding example, further comprising a plurality of convex protrusions forming one of a closed-packed array or a random array or a combination of closed-packed array and a random array of convex protrusions.

Example 15 relates to the method of any preceding example, wherein the first charge polarity and the second charge polarity are substantially identical and wherein the first color is different from the second color.

Example 16 relates to the method of any preceding example, wherein the first charge polarity and the second charge polarity are substantially identical and wherein the first mobility is different from the second mobility.

Example 17 relates to the method of any preceding example, wherein the first charge polarity is different from the second charge polarity.

Example 18 relates to the method of any preceding example, further comprising biasing the front electrode relative to the rear electrode to cause selective movement of the first plurality of electrophoretically mobile particles relative to the second plurality of the electrophoretically mobile particles.

Example 19 relates to a non-transient, machine readable storage medium including machine readable instructions, when executed, to cause one or more processors to perform a method comprising: Identifying a first plurality of electrophoretically mobile particles disposed in a gap between a front electrode and a rear electrode of the TIR display, the first plurality of particles having a first charge polarity, a first color and a first mobility; Identifying a second plurality of electrophoretically mobile particles disposed in the gap between the front electrode and the rear electrode, the second plurality of particles having a second charge polarity, a second color and a second mobility; and biasing the front electrode relative to the rear electrode to cause a movement of the first and the second plurality of electrophoretically mobile particles from the front electrode to the rear electrode; wherein the movement of the first plurality of electrophoretically mobile particles from the front electrode to the rear electrode is faster relative to the movement of the plurality of second electrophoretically mobile particles from the front electrode to the rear electrode.

Example 20 relates to the medium of example 19, wherein the front electrode further comprises one or more protrusions extending towards the gap.

Example 21 relates to the medium of any preceding example, further comprising a plurality of convex protrusions forming one of a closed-packed array or a random array or a combination of closed-packed array and a random array of convex protrusions.

Example 22 relates to the medium of any preceding example, wherein the first charge polarity and the second charge polarity are substantially identical and wherein the first color is different from the second color.

Example 23 relates to the medium of any preceding example, wherein the first charge polarity and the second charge polarity are substantially identical and wherein the first mobility is different from the second mobility.

Example 24 relates to the medium of any preceding example, wherein the first charge polarity is different from the second charge polarity.

Example 25 relates to the medium of any preceding example, further comprising biasing the front electrode relative to the rear electrode to cause selective movement of the first plurality of electrophoretically mobile particles relative to the second plurality of the electrophoretically mobile particles.

It will be apparent to those skilled in the technology of image displays that numerous changes and modifications can be made in the preferred embodiments of the invention described above without departing from scope of the invention. Accordingly, the foregoing description is to be construed in an illustrative and not in a limitative sense, the scope of the invention being defined solely by the appended claims.

What is claimed is:

1. A Total Internal Reflection (TIR) display, comprising:
a transparent TIR sheet, wherein the transparent TIR sheet further comprises a planar surface and a non-planar surface;
a transparent front electrode;
a rear electrode positioned across the transparent electrode to form a gap therebetween;
a first plurality of electrophoretically mobile particles disposed in the gap, the first plurality of particles having a first charge polarity, a first color and a first mobility; and
a second plurality of electrophoretically mobile particles disposed in the gap, the second plurality of particles having a second charge polarity, a second color and a second mobility.

2. The display of claim 1, wherein the non-planar surface further comprises one or more protrusions extending from away from the planar surface.

3. The display of claim 2, further comprising a plurality of convex protrusions forming one of a closed-packed array or a random array or a combination of closed-packed array and a random array of convex protrusions.

4. The display of claim 2, wherein the transparent front electrode is formed over the one or more protrusions extending away from the planar surface.

5. The display of claim 2, wherein the transparent front electrode is integrated with the transparent TIR sheet.

6. The display of claim 1, wherein the first charge polarity and the second charge polarity are substantially identical and wherein the first color is different from the second color.

7. The display of claim 1, wherein the first charge polarity and the second charge polarity are substantially identical and wherein the first mobility is different from the second mobility.

8. The display of claim 1, wherein the first charge polarity is different from the second charge polarity.

9. The display of claim 1, further comprising a third plurality of electrophoretically mobile particles having a third charge polarity, a third color and a third mobility.

10. The display of claim 9, wherein the first charge polarity is substantially similar to the second and the third charge polarities and wherein the first mobility is higher than the second mobility and the second mobility is higher than the third mobility.

11. The display of claim 1, further comprising a color filter.

12. A method to provide a Total Internal Reflection (TIR) display, comprising:
disposing a first plurality of electrophoretically mobile particles in a gap between a front electrode and a rear electrode of the TIR display, the first plurality of particles having a first charge polarity, a first color and a first mobility;
disposition a second plurality of electrophoretically mobile particles in the gap between the front electrode and the rear electrode, the second plurality of particles having a second charge polarity, a second color and a second mobility; and
biasing the front electrode relative to the rear electrode to cause a movement of the first and the second plurality of electrophoretically mobile particles from the front electrode to the rear electrode;
wherein the movement of the first plurality of electrophoretically mobile particles from the front electrode to the rear electrode is faster relative to the movement of the plurality of second electrophoretically mobile particles from the front electrode to the rear electrode.

13. The method of claim 12, wherein the front electrode further comprises one or more protrusions extending towards the gap.

14. The method of claim 13, further comprising a plurality of convex protrusions forming one of a closed-packed array or a random array or a combination of closed-packed array and a random array of convex protrusions.

15. The method of claim 12, wherein the first charge polarity and the second charge polarity are substantially identical and wherein the first color is different from the second color.

16. The method of claim 12, wherein the first charge polarity and the second charge polarity are substantially identical and wherein the first mobility is different from the second mobility.

17. The method of claim 12, wherein the first charge polarity is different from the second charge polarity.

18. The method of claim 12, further comprising biasing the front electrode relative to the rear electrode to cause selective movement of the first plurality of electrophoretically mobile particles relative to the second plurality of the electrophoretically mobile particles.

19. A non-transient, machine readable storage medium including machine readable instructions, when executed, to cause one or more processors to perform a method comprising:
Identifying a first plurality of electrophoretically mobile particles disposed in a gap between a front electrode and a rear electrode of the TIR display, the first plurality of particles having a first charge polarity, a first color and a first mobility;
Identifying a second plurality of electrophoretically mobile particles disposed in the gap between the front electrode and the rear electrode, the second plurality of particles having a second charge polarity, a second color and a second mobility; and
biasing the front electrode relative to the rear electrode to cause a movement of the first and the second plurality of electrophoretically mobile particles from the front electrode to the rear electrode;
wherein the movement of the first plurality of electrophoretically mobile particles from the front electrode to the rear electrode is faster relative to the movement of the plurality of second electrophoretically mobile particles from the front electrode to the rear electrode.

20. The medium of claim 19, wherein the front electrode further comprises one or more protrusions extending towards the gap.

21. The medium of claim 20, further comprising a plurality of convex protrusions forming one of a closed-packed array or a random array or a combination of closed-packed array and a random array of convex protrusions.

22. The medium of claim 19, wherein the first charge polarity and the second charge polarity are substantially identical and wherein the first color is different from the second color.

23. The medium of claim 19, wherein the first charge polarity and the second charge polarity are substantially identical and wherein the first mobility is different from the second mobility.

24. The medium of claim 19, wherein the first charge polarity is different from the second charge polarity.

25. The medium of claim 19, further comprising biasing the front electrode relative to the rear electrode to cause selective movement of the first plurality of electrophoretically mobile particles relative to the second plurality of the electrophoretically mobile particles.
